(19) United States
(12) Patent Application Publication
(10) Pub. No.: US 2023/0145742 A1
(43) Pub. Date: May 11, 2023

(54) SYSTEMS AND METHODS FOR CONTINUOUS EXTRUSION OF A SOLID BODY OR PART FROM MONOMER SOLUTIONS, AND GROWING SOFT ROBOTS UTILIZING THE SAME

(71) Applicant: Regents of the University of Minnesota, Minneapolis, MN (US)

(72) Inventors: Christopher J. Ellison, Eden Prairie, MN (US); Timothy M. Kowalewski, St. Paul, MN (US); Lorraine F. Francis, Minnetonka, MN (US); Matthew M. Hausladen, Minneapolis, MN (US); Boran Zhao, Minneapolis, MN (US); Matthew Kubala, Minneapolis, MN (US)

(73) Assignee: Regents of the University of Minnesota, Minneapolis, MN (US)

(21) Appl. No.: 17/985,488

(22) Filed: Nov. 11, 2022

Related U.S. Application Data
(60) Provisional application No. 63/278,300, filed on Nov. 11, 2021.

(51) Int. Cl. B25J 18/02; B29C 48/09; B29C 48/94; B29C 48/91

(52) U.S. Cl. CPC B25J 18/02; B29C 48/09; B29C 48/94; B29C 48/91; B29C 2948/92066

(57) ABSTRACT

Some aspects of the present disclosure relate to systems and methods for polymer-based extrusion. Some non-limiting embodiments provide for extrusion of a liquid photopolymerizable monomer in a channel/die with the aid of a lubricating component, such as poly(dimethylsiloxane)-graft-poly(ethylene oxide) grafted copolymer (PDMS-PEO), and driven by fluid pressure (e.g., a fluid pump). Other aspects of the present disclosure relate to growing soft robots. Some non-limiting embodiments provide a novel class of robots which grow in an environment by growing at their tip (or robot head) by using the self-lubricated photopolymerization extrusion techniques of the present disclosure. Emulating biological tip growth, this process is facilitated by converting an internal monomer fluid into the solid body of the growing robot through polymerization.

### RELATED APPLICATIONS

This Non-Provisional patent application claims the benefit of the filing date of U.S. Provisional Patent Application Ser. No. 63/278,300, filed Nov. 11, 2021, entitled “SYSTEMS AND METHONDS FOR CONTINUOUS EXTRUSION OF A SOLID BODY OR PART FROM MONOMER SOLUTIONS, AND GROWING SOFT ROBOTS UTILIZING THE SAME,” the entire teachings of which are incorporated herein by reference.

### GOVERNMENT SUPPORT CLAUSE

This invention was made with government support under EFMA-1830950 awarded by the National Science Foundation. The government has certain rights in the invention.

### BACKGROUND

The present disclosure relates to continuous extrusion or growing of a solid polymer (e.g., thermoplastic or thermoset polymer) body or part from a liquid or flowing polymerizable material. More particularly, it relates to systems and methods for continuous extrusion or growing of a solid body or part from a liquid monomer via polymerization. Some embodiments relate to growing soft robots.

Three-dimensional (3D) polymer parts are conventionally formed or manufactured by melt extrusion processes. With thermoplastic melt extrusion techniques, synthesized plastic pellets are melted at high temperatures and reformed using complex machinery (e.g., a twin screw extruder). The extrusion process typically requires high forces and temperatures to convey the polymer (e.g., preformed polymer) due to the high viscosity of the polymer melt; in fact, many common polymer materials of possible interest, such as certain monomers (e.g., thermosetting polymer chemistries), have strong adhesion to many surfaces (metal, glass, other polymers), preventing use with conventional continuous extrusion techniques as the adhesion is too high for removal from the channel/die. More recently, photopolymerization-based 3D printing techniques (e.g., stereolithography or vat photopolymerization) have been developed that directly convert a liquid resin into solid parts via photopolymerization. While viable, known 3D printing techniques are unable to make very high-aspect parts (as compared to thermoplastic melt extrusion) due, at least in part, to build volume constraints and economics associated with the layer-by-layer construction approach.

In the field of soft robots, other techniques (substantively differing from extrusion and 3D printing) have been considered for providing a continuum robot that “grows”. Soft robotics is generally understood to be a specified subfield of robotics dealing with constructing robots from highly compliant materials, similar to those found in living organisms. In contrast to robots built from rigid materials, soft robots allow for increased flexibility and adaptability for accomplishing tasks, as well as improved safety when working around humans. With this in mind, so-called “vine” soft robots have been proposed, for example as described in U.S. Patent Application Publication No. 2019/0217908 (Hawkes et al.), the entire teachings of which are incorporated herein by reference. The vine growing robot has a thin-walled, hollow, pressurized, compliant body that elongates or “grows” by everting from its tip new wall material that is stored inside the body. Another example is a “plantoid” (or plant-inspired growing robot) that manufactures its “growing” body through a filament additive manufacturing process as described, for example, by Sadeghi et al., “Passive Morphological Adaptation for Obstacle Avoidance in a Self-Growing Robot Produced by Additive Manufacturing”, Soft Robotics, Vol. 7, No. 1 (2020) the entire teachings of which are incorporated herein by reference. While interesting, drawbacks exists with these and other growing soft robot designs.

### SUMMARY

The inventors of the present disclosure recognized that a need exists for improvements in techniques for forming polymer bodies or parts from various materials. The inventors of the present disclosure recognized that a further need exists for improvements in growing soft robots.

Some aspects of the present disclosure relate to systems and methods for polymerization-based extrusion, for example photopolymerization-based extrusion. Some non-limiting embodiments provide for extrusion of a liquid photopolymerizable monomer in a channel/die with the aid of a lubricating component, poly(dimethylsiloxane)-graft-poly(ethylene oxide) grafted copolymer (PDMS-PEO) and driven by fluid pressure (e.g., a fluid pump). Some of the PDMS-PEO block polymer goes to the channel interface, forming a liquid lubricating layer that conforms to the shape of the channel (with this shape optionally being varied or changed during the extrusion process). This allows for solid profiled objects to be made by direct and continuous photopolymerization of a liquid monomer to a solid object (similar to stereolithography (SLA) 3D printing, but in an extrusion setup). In other embodiments, the extrusion-based systems and methods of the present disclosure utilize other photopolymerizable monomers and/or lubricating agents. In yet other embodiments, the extrusion-based systems and methods of the present disclosure utilize monomers solutions formulated to solidify in response to localized stimuli other than radiation/light, such as heat, polymerization catalyst, etc.

Other aspects of the present disclosure related to growing soft robots. Some non-limiting embodiments provide a novel class of robots which grow in an environment by growing at their tip by using the self-lubricated photopolymerization extrusion techniques of the present disclosure. Emulating biological tip growth, this process is facilitated by converting an internal monomer fluid into the body of the growing robot through photopolymerization. The growth of the body facilitates further monomer to be supplied to the head of the robot.

### BRIEF DESCRIPTION OF THE DRAWINGS

FIG. 1 schematically illustrates portions of an extrusion system and methods in accordance with principles of the present disclosure;

FIG. 2 schematically illustrates portions of another extrusion system and methods in accordance with principles of the present disclosure;

FIG. 3 is a perspective view of an extrusion system in accordance with principles of the present disclosure;

FIG. 4 schematically illustrates portions of a growing soft robot in accordance with principles of the present disclosure;

FIG. 5A schematically illustrates portions of a growing soft robot in accordance with principles of the present disclosure, including a robot head;

FIG. 5B schematically illustrates operation of the growing soft robot of FIG. 5A;

FIGS. 6A-6C are perspective views depicting operation of a growing soft robot in accordance with principles of the present disclosure;

FIG. 7 is an operating diagram for growing soft robots of the present disclosure;

FIGS. 8A-8C are perspective views depicting operation of a growing soft robot of the present disclosure traversing a tortuous path;

FIG. 9A is a side view of robot head useful with the growing soft robots of the present disclosure;

FIG. 9B is an exploded view of the robot head of FIG. 9A;

FIG. 10 lists properties of various additive materials described in the Examples section;

FIGS. 11A-11C identify characteristics of glass materials described in the Examples section;

FIGS. 12A-12C are photographs of an extrusion system and process described in the Examples section;

FIG. 13A is a plot of measure pressure over time for extrusions described in the Examples section;

FIG. 13B is a plot of steady-state pressure required to extrude an annular tube as described in the Examples section;

FIG. 14 presents photorheology values for flexible and rigid thiol-ene resins with measured linear shrinkage as described in the Examples section;

FIG. 15 is a graph of measured diameters for annular extrusions described in the Examples section;

FIG. 16 is a photograph of various objects produced by extrusions of the Examples section;

FIG. 17 is a plot of representative tensile stress-strain curves of thiol-ene resins used in extrusions of the Examples section;

FIG. 18 presents mechanical properties of thiol-ene monomer resins as described in the Examples section;

FIG. 19A is a plot of measured pressure over time for two extrusions described in the Examples section;

FIG. 19B schematically represents an extrusion process described in the Examples section;

FIG. 20 is a plot of measured fluid pressure over time during operation of a growing soft robot of the Examples section;

FIG. 21 is a graph of pressure behavior as a function of tip velocity of growing soft robots described in the Examples section;

FIG. 22 is a plot presenting a comparison of experimental average velocities and theoretical velocity of growing soft robots of the Examples section;

FIG. 23 is a plot illustrating effect of PDMS-PEO block copolymer concentration on the steady-state pressure required for unimpeded horizontal growth of a growing soft robot of the Example section;

FIGS. 24A-24D are plots illustrating photopolymerization characterization and depth of cure of growing soft robots of the Examples section;

FIG. 25 is a plot of flow rate ramps for experimental maximum velocity determinations for growing soft robots of the Examples section;

FIG. 26 is a graph presenti8n8g UV-visible absorption spectra of thiol-ene monomer and photopolymerized film used with growing soft robots of the Examples section;

FIG. 27A is a time-lapse photograph of a growing soft robot traversing a tortuous path as described in the Examples section;

FIG. 27B is a graph presenting pressure measurements over time for the example growing soft robot operation of FIG. 27A;

FIG. 28 is a side view of a robot head with burrowing adaptor used with growing soft robots of the Examples section;

FIG. 29A presents photographs of a growing soft robot of the Examples section burrowing through simulated soil; and

FIG. 29B is a graph presenting pressure measurements over time for the example growing soft robot operation of FIG. 29A.

### DETAILED DESCRIPTION

Some aspects of the present disclosure relate to systems and methods for continuously forming a solid polymer body or part from a liquid material, such as liquid polymerizable solution formatted to solidify in response to an external stimulus (e.g., localized heat, electromagnetic radiation (e.g., UV light), polymerization catalyst, etc.). For example, some systems and methods of the present disclosure provide for the extrusion of solid polymer macroscopic objects from a photopolymerizable monomer. Other aspects of the present disclosure relate to growing soft robots, such as a growing soft robot utilizing the formation techniques described herein. In this regard, polymerization, for example photopolymerization, can offer a unique approach for the localized buildup of a structure useful as a growing soft robot.

### Extrusion by Self-Lubricated Interface Polymerization (E-SLIP)

Some techniques of the present disclosure uniquely provide for the polymerization of a pressure-driven flow of monomer solution, effectively achieving extrusion of a liquid polymerizable solution as a solid body for a wide variety of end use applications, for example growing soft robots. While light-based fabrication of microfibers or microparticles in microfluidic devices has been previously reported, there is no similarly available technique for simultaneous flow and photopolymerization on a macroscale. Polymerization, for example photopolymerization, permits the generation of three-dimensional (3D) objects from a liquid resin, with spatial and temporal control over the mechanical and chemical properties of produced objects.

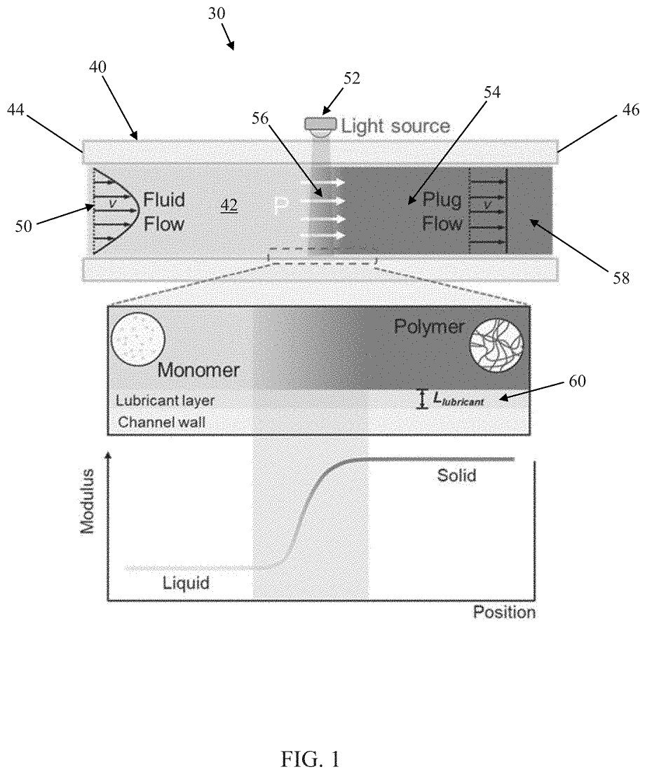

With the above in mind, FIG. 1 schematically illustrates one example of a polymerization extrusion system 30 and methods of the present disclosure. A channel structure (or die) 40 defining a channel 42 open to opposing inlet and outlet sides 44, 46 is provided. The channel 42 can have various perimeter shapes (e.g., regular or irregular); further, the shape of the channel 42 can be defined by the channel structure 40 alone, or in combination with one or more additional bodies disposed within the channel structure 40. A supply of liquid monomer solution 50 (identified generally in FIG. 1) is delivered to the inlet side 44. A formulation of the monomer solution 50 is described in greater detail below. In general terms, however, the monomer solution 50, as supplied to the channel 42, includes a monomer in flowable or liquid form that will polymerize and solidify in the presence of a localized stimulus or stimuli. With this in mind, a stimulus source 52 is located proximate the channel structure 40, arranged to emit a stimulus (e.g., energy, polymerization catalyst, etc.) toward the channel 42 (e.g., the stimulus source 52 can be located outside of the channel structure 40 or inside of the channel structure 40). A format of the stimulus source 52 is selected in accordance with a formulation of a monomer solution 50, and in particular is selected to effect polymerization of the liquid monomer solution 50. For example, where the monomer solution 50 includes a liquid photopolymerizable monomer, the stimulus source 52 can be or include a radiation source (or “light source” as shown in the non-limiting example of FIG. 1) that emits radiation at wavelengths causing polymerization of the photopolymerizable monomer (e.g., the stimulus source 52 can include one or more UV LEDs). The stimulus source 52 can assume other forms corresponding to a formulation of the monomer solution 50 (e.g., the stimulus source 52 can be formatted to radiate heat or other stimulus). Regardless, with optional embodiments in which the stimulus source 52 is located outside of the channel structure 40, the channel structure 40 is configured to be transmissive to the stimulus generated by the stimulus source 52. For example, where the stimulus source 52 is formatted to emit UV light (or light at other wavelengths), the channel structure 40 is formed of a transparent or translucent material (e.g., glass) permitting passage of light. The monomer solution 50 is selectively polymerized (e.g., photopolymerized) into a solid crosslinked network 54 in a polymerizing region 56 via stimulus (e.g., light) from the stimulus source(s) 52. A cured polymer 58 (or “plug”, it being understood that the term “plug” is used generally and is not meant to imply a particular shape or form) results that fills the channel 42 and is expelled from the outlet side 46 as an extruded object or body by the incoming monomer solution 50 due to fluid pressure.

While the channel structure 40 (and thus the channel 42 defined thereby) is generally shown as having a linear and solid construction, in other embodiments the channel structures of the present disclosure can be configured to effect a non-linear shape to the cured polymer 58 and/or to effect a varying or variable shape to the cured polymer 58. For example, in some embodiments, the channel 42 can have a shape that effects a bend or other non-linear attribute to the cured polymer 58 (thus generating a bend in a profiled part produced by the polymerization extrusion system). Alternatively or in addition, the channel structure 40 can be configured to vary a perimeter shape of the channel 42 in space and/or time to achieve a desired extruded solid profile (e.g., the perimeter shape of the channel 42 can change during the extrusion process to effect a varying shape in the resultant extruded solid body or part). In some optional embodiments, the extrusion systems and methods of the present disclosure can include features that effect a curved or bent extruded body. By way of non-limiting example, a larger diameter, flexible tube can be positioned at the outlet of the extrusion system (or growing robot) so that it is surrounding the body (e.g., tube) that is currently being printed and extruded. This outer tube can be connected to the extrusion system's ring of primary UV LEDs or other stimulus source (or the growing robot's head) via cables on the far end, and rigidly attached at the other. These cables can extend from the far end of the outer tube to one or more motors attached to the robot's head. When these motors actuate, they pull the cables in such a way that the outer tube is pulled and bent. The bending of this outer tube contacts the extruded polymer body (e.g., tube) and the force causes the extruded body (e.g., tube) to bend in the same direction. Mounted at some position along the outer tube (typically halfway along the tube so that it is positioned where the tube bends most) is a secondary ring of UV LEDs. The primary ring of LEDs (e.g., in the robot's head) partially cures the monomer so that it is gelled and structurally stable. The extruded body (e.g., tube) is then bent by the outer tube as mentioned above, and the secondary ring of LEDs shines on and finishes polymerizing the monomer in the extruded tubes, locking them into the current bent configuration. The monomer flowing inside the extruded body (e.g., tube) is prevented from polymerizing due to the secondary ring of LEDs due to a length of FEP tube situated inside the extruded tube at the position of the second ring of LEDs. This FEP tube is connected to the FEP tube in the head (the internal channel) by a cable.

In some embodiments, the methods of the present disclosure can be performed on a continuous or constant basis (e.g., to continuously supplying the monomer solution 50 to the channel 42 and continuously extruding the cured polymer 58). In other embodiments, the methods can be performed on a discrete or otherwise time-varying basis. By way of non-limiting example, the systems and methods can optionally include one more mechanisms that effect stepped growth in the cured polymer 58 as it is extruded, such as a mechanism (e.g., a ratchet-type mechanism) that delivers discrete injected volumes of the monomer solution 50.

The monomer solutions of the present disclosure can include a polymerizable monomer and lubricating agent. Features of the lubricating agent are described below. Various types of monomers can be used as the monomer component of the monomer solutions of the present disclosure. In some non-limiting examples, the monomer component can be a photopolymerizable monomer (although other polymerizable polymers that may or may not be photopolymerizable monomers are also acceptable). The photopolymerizable monomer can be a thiol-ene based monomer chemistry. The thiol-ene based monomer chemistry can exhibit one or more properties beneficial to the systems and methods of the present disclosure, such as rapid curing kinetics, reduced oxygen inhibition, low shrinkage, and availability of monomer species. Other monomer or photopolymer chemistries are also acceptable. For example, the resin of the monomer solution can include or comprise one or more of acrylates, polyurethane acrylates, epoxide acrylates; with non-limiting examples in which the polymerizable monomer is a photopolymerizable monomer, the monomer resin can optionally be any free radical-based monomer or cationic-based monomer. As a point of reference, the present disclosure is not limited to photopolymerizable monomers; monomers useful with the present disclosure can be formatted such that polymerization is initiated/facilitated by one or more of radiation, heat, or chemically initiated by a local catalyst, redox agent, etc.

With respect to the lubricating agent of the monomer solutions of the present disclosure, a main challenge of the process implicated by FIG. 1 lies in overcoming the frictional and adhesive forces that arise from channel-polymer interactions, such that continuous extrusion is possible. Adhesion is expected to arise mainly from chemical bonding and physical interlocking between polymer and the glass (or other channel structure material) channel wall. It has been suggested that a fluorinated silane coupling agent can be applied to the glass surface of the channel structure to reduce the surface energy of the glass. However, it was surprisingly found that successful extrusion was not possible through surface modification alone. Limiting adhesion can be a significant challenge in light-based additive manufacturing, which has previously been mitigated in continuous printing by the introduction of a non-reactive layer in between the resin and the solid interface, either by polymerization inhibition or use of an immiscible liquid.

With the above in mind, some non-limiting examples of lubricating agents useful with the monomer solutions of the present disclosure include a block copolymer amphiphile, poly(dimethylsiloxane)-graft-poly(ethylene oxide) grafted copolymer (PDMS-PEO) containing ˜65% poly(ethylene oxide) content by weight, to the monomer solution as a lubricating component. By doing so, it was surprisingly found that selective adsorption of the block copolymer onto the channel wall facilitates the formation of a liquid interface (or “lubricant layer” 60 in FIG. 1) composed predominantly of PDMS-PEO that conforms to the surface of the channel structure 40 otherwise defining the channel 42. Due to the presence of the block copolymer in the bulk solution, the lubricating layer is able to be formed spontaneously and replenished continuously during extrusion. In doing so, continuous extrusion is possible, with the developed fabrication methodology termed extrusion by self-lubricated interface polymerization (E-SLIP). Other lubricating agent formulations can also be employed. For example, the lubricating agent can optionally include or comprise PDMS-b-PEG, PPG, fluorinated PDMS-b-PEG, etc.; the fluorinated PDMS-b-PEG can comprise the lubricating amphiphile, optionally with 35˜65% by weight PEG content. Liquid variants of PEO-PBO-PEO triblock polymers, PEO-PPO-PEO pluronics, and the like are also acceptable. In yet other embodiments, the lubricating agent can have other forms.

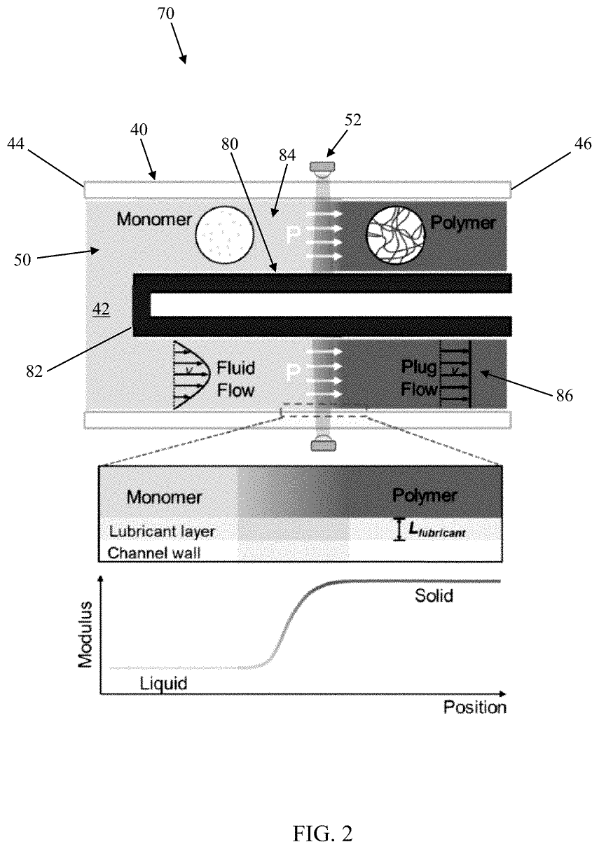

As mentioned above, the extrusion systems and methods of the present disclosure can be configured to generate, or extrude, objects with a variety of different shapes or formats. For example, while FIG. 1 implicates a solid body-type extruded object, in other embodiments, annular or non-solid bodies can be provided. In this regard, FIG. 2 schematically illustrates another example of polymerization extrusion system 70 and methods of the present disclosure, configured to generate or extrude an annular body. The system 70 is akin to the system 30 (FIG. 1), and includes the channel structure 40 defining the primary channel 42 open to the opposing inlet and outlet sides 44, 46. The stimulus source 52 is arranged to emit a stimulus (e.g., energy, a polymerization catalyst, etc.) toward the primary channel 42. In addition, a rod 80 is maintained within the primary channel 42. The rod 80 can have the closed-end tubular shape shown, or can be solid. Regardless, an end wall 82 of the rod 80 is proximate, or faces, the inlet side 44 such that the liquid monomer solution 50 entering the channel structure 40 at the inlet side 44 flows around the end wall 82. The rod 80 occupies a portion of the primary channel 42, with an annular channel 84 being established between the rod 80 and the channel structure 40. The monomer solution 50 flows through the annular channel 84 and is selectively polymerized (e.g., photopolymerized) into a solid crosslinked network via stimulus (e.g., light) from the stimulus source(s) 52. A cured polymer 86 (or “plug”, it being understood that the term “plug” is used generally and is not meant to imply a particular shape or form) results that fills the annular channel 84 and is expelled from the outlet side 46 by the incoming monomer solution 50 due to fluid pressure.

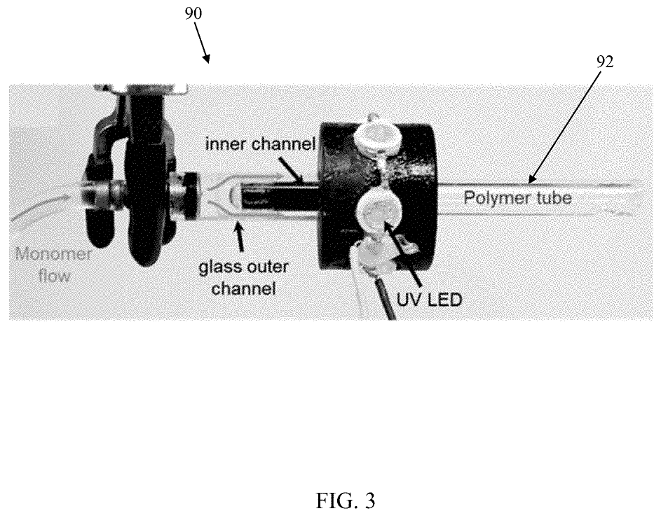

One non-limiting example of a system 90 implementing the E-SLIP processes of the present disclosure, and utilizing the optional photopolymerizable monomer, is shown in FIG. 3. The system 90 includes an annular channel set-up is provided (akin to the system 70 of FIG. 2), with an inner rod (black fluorinated ethylene propylene) disposed within an outer (glass) channel structure shown. With this construction, monomer dispensed into the glass channel flows over the inner rod (i.e., between the inner rod and the outer channel structure) to generate an annular or tube-like shaped extrusion 92 (it being understood that shapes other than annular can be provided; channels with the ability to vary shape spatially or temporally can be provided; and channels can be constructed of materials other than glass or fluorinated ethylene propylene can be employed). A ring supporting a plurality of ultraviolet LED light sources is assembled about the glass channel. The monomer solution (“Monomer flow”) is photopolymerized as it flows to and beyond the light sources, forming a solid polymer tube which is expelled or extruded from the outer channel.

The inventors of the present disclosure have surmised that lubrication is initiated by preferential wetting of the PDMS-PEO block polymer, due to its amphiphilic nature, as compared to the monomer solution without block copolymer. The higher initial PDMS-PEO concentration, the better covering of the glass surface by the lubricant during the wetting process, thus leading to decreased extrusion pressure. By utilizing a low viscosity liquid monomer (for example, approximately 50 mPa-s) and self-lubricated interface, E-SLIP operates at low pressures (˜10 kPa), requiring only simple and inexpensive equipment.

An inherent advantage of polymerization (e.g., photopolymerization), as the method for forming the solid structure, is the ability to generate parts with a broad range of physical and mechanical properties by tuning the chemistry. The resins can be tuned from flexible to rigid by varying the molecular ratio between acrylate components. The inventors of the present disclosure have surmised that E-SLIP is likely to be compatible with other chemistries, expanding the design space of possible functional monomers and block copolymers.

Growing Soft Robot

The systems and methods of the present disclosure as described above can be useful in wide variety of end use applications. For example, manufacturing general profiled parts through self-lubricated extrusion. In other embodiments, the systems and methods of the present disclosure can be utilized with or as a soft robot, and in particular a growing soft robot.

By way of background, soft robots are often designed to mimic mechanical characteristics similar to living tissues. Diverse creatures and cells across biological kingdoms such as plant roots, fungal hyphae, and pollen tubes, leverage a particular method of growth, known as tip growth, as a strategy to navigate and interact with their environment. Tip growth is characterized by anisotropic addition of new material at the growing end of a body, with only the tip in motion relative to the environment. This localized growth greatly reduces the resistance imposed by the surroundings and permits an agile response to environmental conditions. Therefore, tip growing organisms are able to generate large, complex structures over time, traverse constrained environments, such as soil or biological tissue, and navigate according to environmental stimuli, such as light, chemical gradients, or mechanical impedance.

Scientists and engineers have often looked to nature for inspiration for the next generation of materials and robots, with particular interest towards soft robots composed of compliant materials that mimic living tissues and organism motions. In this vein, pioneering work has sought to translate the benefits of tip growth into engineered systems. These works utilized the pressurized eversion of a thin polymer film or a filament-based additive manufacturing process to build out structure in a manner akin to tip growth. However, both these designs rely on a continuous, solid-state supply of building material, which leads to a rapid rise in internal friction during growth on tortuous paths, limiting ultimate extension. Therefore, in order to overcome these limitations, the inventors of the present disclosure sought to highlight and leverage principles of tip growth found in natural systems, which produce structures with substantial tortuosity, and incorporate them into a synthetic analog.

The mechanisms of tip growth in the well-studied cases of fungal hyphae, root tips, and pollen tubes share several underlying principles. The first principle is that a major driver of growth is fluid pressure. This pressure is thought to arise from the internal turgor pressure within cells, which is generated by an osmotic potential between the fluid-filled cell and its environment. As internal pressure deforms an extensible cell wall, its selective yielding at the tip accommodates growth. The second principle is that growth occurs through localized cell wall synthesis. Cell wall components, namely polysaccharides such as chitin in fungi, cellulose in algae and plants, and glycoproteins, are polymerized at the tip to locally build up the structure. Lastly, the third principle is fluid-mediated material transport, in which cell wall components are transported to the tip by both flow-based and active means (such as vesicular transport via the cytoskeleton). By combining these three principles, organisms are able to generate large forces and lengthen at the tip with minimal friction with their surroundings.

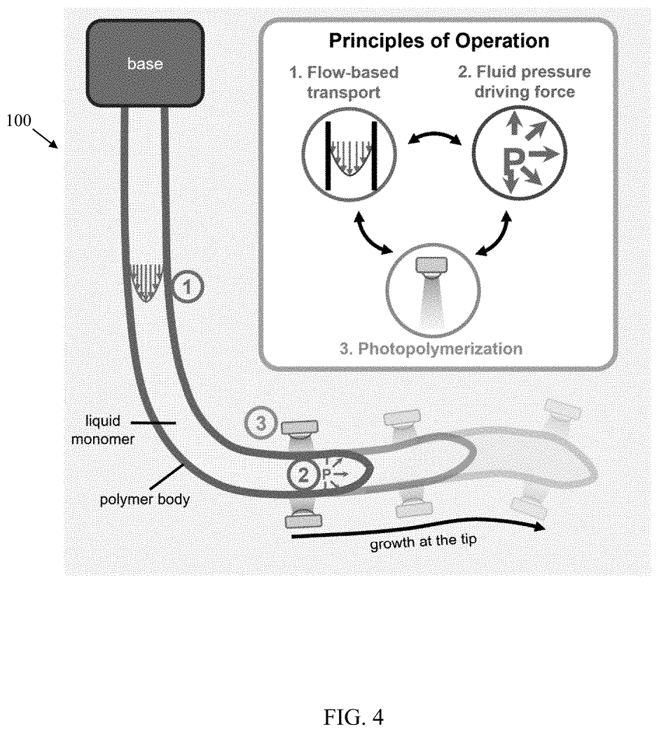

Against the above background, the growing soft robots of the present disclosure emulate these biological principles in a synthetic system of tip growth in analogy to the capabilities evolved by nature. In some examples, the growing soft robots of the present disclosure utilize photopolymerization (although other stimulus-induced polymerizations, such as thermal polymerization, catalytic polymerization, etc., are also acceptable). Photopolymerization offers a unique approach for the localized buildup of structure that is central to tip growth. Photopolymerization permits the generation of three-dimensional (3D) polymer objects from a liquid resin, with spatial and temporal control over the mechanical and chemical properties of produced objects. Due to these advantages, it has provided new capabilities in manufacturing technologies such as light-based additive manufacturing, soft lithography, solvent-free fiber processing, and flow lithography. In some embodiments of the present disclosure, a growing soft robot is provided with a synthetic analog of tip growth. For example, a simplified representation of the principles of operation of a growing soft robot 100 in accordance with the present disclosure is depicted in FIG. 4. As shown, and as highlighted in the insert of FIG. 4, photopolymerization enables the local and rapid polymerization of the structure, while a pressure-driven flow can be utilized to supply a liquid monomer to a site of photopolymerization at the tip and to drive growth. The growing soft robot 100 of FIG. 4 incorporates a synthetic growth concept inspired by the biological mechanism for growth and capable of replicating the biological functionalities of tip-growing organisms, with photopolymerization building up structure locally and monomer solution used to transmit force and transport material. In other embodiments, thermal polymerization, catalytic polymerization, or other polymerization formats can be employed.

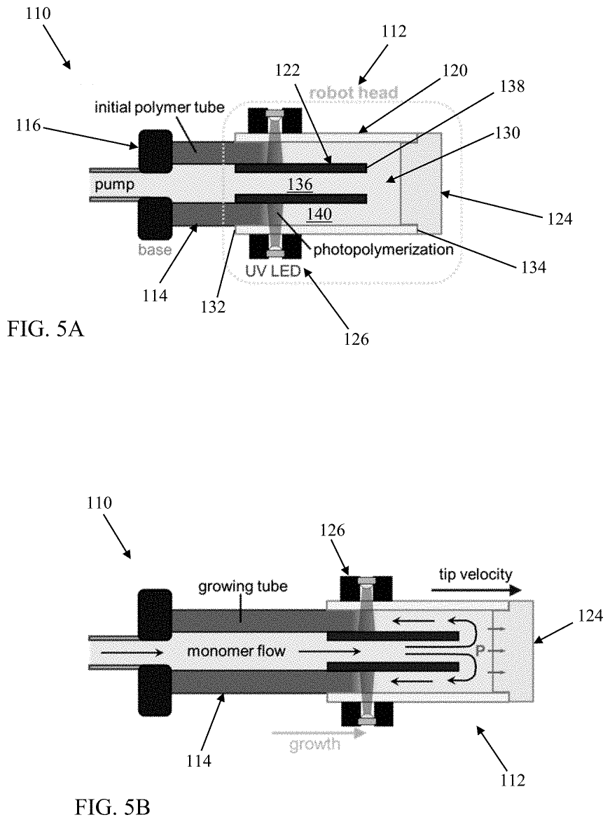

In some embodiments, the growing soft robots of the present disclosure incorporate the E-SLIP systems and methods described above. FIGS. 5A and 5B illustrate one non-limiting example of a growing soft robot 110 in accordance with principles of the present disclosure and implementing the E-SLIP processes described above. As a point of reference, some features of the growing soft robot 110 as described below and as labeled in FIGS. 5A and 5B reflect optional embodiments in which a photopolymerizable monomer is employed. With other polymerizable formats (e.g., thermal polymerization, catalytic polymerization, etc.), the growing soft robot 110 can be modified to incorporate corresponding components. The growing soft robot 110 includes a robot head 112, a robot body 114 (“initial polymer tube” in FIG. 5A), a base 116 and a monomer solution source assembly (not shown, but generally identified as “pump” in FIG. 5A). The robot head 112 includes an outer channel structure or tube 120, an inner tube 122, a cover 124, and an electromagnetic radiation source assembly 126. The outer channel structure 120 is formed of a material transparent or translucent to the radiation energy (e.g., UV light) from the electromagnetic radiation source assembly 126, and defines a passageway 130 between opposing trailing and leading ends 132, 134 thereof. The inner tube 122 is formed of a material that blocks or shields radiation energy from the electromagnetic radiation source assembly 126 and defines an internal passage 136. The cover 124 is assembled to the outer channel structure 120 at the leading end 134, in a manner that closes the passageway 130; in other embodiments, the outer channel structure 120 and the cover 124 can be provided as a single, integrally formed body. The inner tube 122 is maintained within the passageway 130 such that a terminal end 138 of the inner tube 122 is spaced from the cover 124. A channel 140 is defined between the outer channel structure 120 and the inner tube 122. In some embodiments, the outer channel structure 120 and the inner tube 122 combine to form the channel 140 to have an annular profile shape. Other shapes for the channel 140 are also acceptable that may or may not be annular, and may be regular or irregular and/or vary spatially over time. In some non-limiting examples, a height or thickness of the channel 140 can be on the order of 0.2-10 millimeters (mm), although other dimensions, either greater or lesser, are also acceptable. Finally, the electromagnetic radiation source assembly 126 includes one or more radiation sources (e.g., UV LEDs), and is arranged relative to the outer channel structure 120 so as to direct emitted radiation energy through the outer channel structure 120 to a region of the annular channel 140.

The robot body 114 is tubular, formed of a material compatible with the photopolymerizable monomer solution (e.g., the same polymer as provided with the monomer solution source assembly, a compatible resin, etc.). The base 116 is secured to the robot body 104 opposite the robot head 112, and is fluidly connected to the monomer solution source assembly. The monomer solution source assembly includes a reservoir containing a supply of the monomer solution (in liquid or flowable form), and one or more devices appropriate for delivering the monomer solution to the base (e.g., a pump and corresponding tubing). With this construction, the monomer solution source assembly can continuously deliver monomer solution to the base 116 that in turn direct the flow of the monomer solution into the robot body 114.

While the growing soft robot 110 has been described as implementing a photopolymerizable monomer solution, other liquid dispersions or formulations are also acceptable (e.g., other polymerizable monomer formulations or mixtures such as colloids or suspensions where the liquid may transport solid particles to improve the overall growth process and extruded solid). For example, growing soft robots of the present disclosure can utilize a monomer solution formulated to polymerize in the presence of a localized stimulus other than electromagnetic radiation, such as a thermal polymerizable monomer solution, polymerization catalyst, etc., as described above. With these and related embodiments, the electromagnetic radiation source assembly 126 shown in FIGS. 5A and 5B can be replaced by a source of energy or stimulus formatted in accordance with the particular polymerizable monomer formulation (e.g., where the polymerizable monomer is formulated to convert to polymer by thermal energy, a thermal energy source is used in place of the electromagnetic radiation source assembly 126). With these and related embodiments, a material and construction of the outer channel structure 120 is configured to be transmissive to the particular stimulus format, whereas a material and construction of the inner tube 122 in configured to block the particular stimulus. Further, while the growing soft robot 110 of FIGS. 5A and 5B reflects an optional arrangement in which the electromagnetic radiation source assembly 126 is located external the outer channel structure 120, in other embodiments the radiation source assembly 126 (or other stimulus source) can be located inside of the outer channel structure 120. In addition, while FIGS. 5A and 5B generally reflect the channel 140 being defined by the outer channel structure 120 and the inner tube 122 as discrete components, in other embodiments, a channel (or multiple channels) can be defined in thickness of a wall of the outer channel structure 120 (such that, for example, the inner tube 122 can be omitted in some embodiments). Stated otherwise, in some embodiments, the inner tube 122 can be considered part of the outer channel structure 120, with the outer channel structure 120 itself forming the channel 140 (and optionally the internal passage 136).

E-SLIP, as implemented in the growing soft robot 110, enables three biological principles of tip growth to be realized in a synthetic growing system. The robot's extension is initiated with the robot body 114 (e.g., short length of polymer tube (˜5 cm)), for example generated previously using E-SLIP as described above, a separately formed tube (e.g., 3D tube formed from a compatible resin), etc. With additional reference to FIG. 5B, this tube 114 serves as the channel to deliver monomer solution to the robot head 112, paralleling the fluid-mediated transport principle in biological systems. In the robot head 112, the flow of monomer material from the robot body 114 flows into the internal passage 136 of the inner tube 122. Because the inner tube 122 is formed of a material that blocks the stimulus from the source 126, the polymerizable solution within the inner tube 122 does not experience polymerization. The flow of monomer exits the inner tube 122 near the cover 124 and is directed back through the channel 140 and past the radiation energy source(s) 126 for localized polymerization, analogous to the local cell wall synthesis. The fluid pressure propels the robot head 112 forward (generally noted by the arrow labeled as “tip velocity” in FIG. 5B), enabling the continuous construction of the robot body 114, which mirrors the turgor pressure-based driving force in biological systems. Once formed, the polymerized body 114 remains static relative to its surroundings, with only the robot head 112 moving relative to the environment. The constant flow of monomer supplied to the robot head 112 and applying a force to the cover 124 drives growth by moving the robot head 112 forward as well as generating the robot body 114 through continuous polymerization. Utilizing this bioinspired approach, the growing soft robot 110 generates its own polymer structure and can lengthen by hundreds of percent, with the ultimate length limited by the amount of monomer in the reservoir.

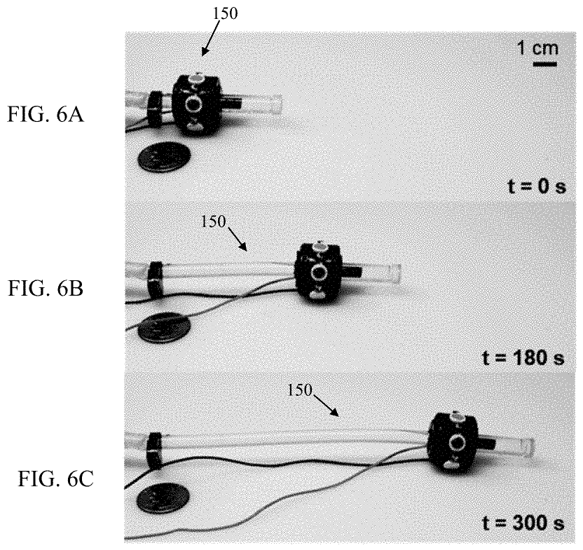

FIGS. 6A-6C are images of a non-limiting example growing soft robot 150, akin to the growing soft robot 110 of FIGS. 5A and 5B, growing over time at a flow rate of 1 ml/min. As a point of reference, the example growing soft robot 150 of FIGS. 6A-6C employs a photopolymerizable monomer solution and a corresponding UV light stimulus; these represent optional, non-limiting features of the growing soft robots of the present disclosure.

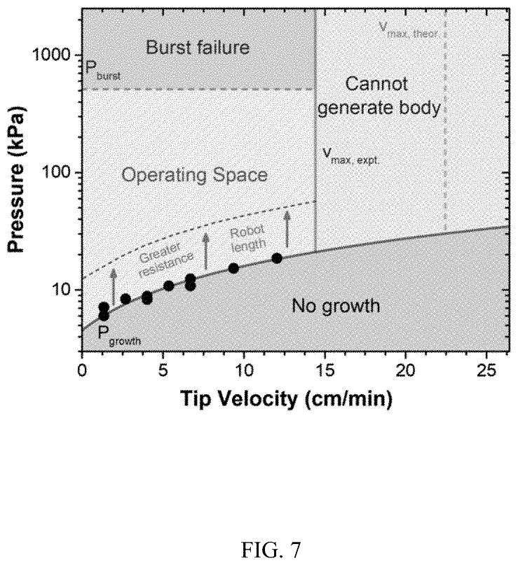

The tip velocity and the fluid pressure are, in some embodiments, parameters of interest that can govern the behavior of the growing soft robots of the present disclosure. The growth behavior is constrained in pressure and velocity on three boundaries: a minimum steady-state pressure required to overcome the internal and external resistive forces; a maximum pressure dictated by the burst pressure of the robot body; and a maximum velocity determined by the polymerization kinetics of the monomer solution. With this in mind, FIG. 7 presents these boundaries for some embodiments of growing soft robots of the present disclosure, growing unimpeded in a horizontal path and a given set of operating parameters and other variables. FIG. 7 represents an operating diagram for a horizontal growing soft robot in accordance with principles of the present disclosure, with bounds of a minimum pressure for growth, the maximum theoretical tip velocity determined from polymerization kinetics, and the upper pressure at which the polymerized tube bursts. Bounds determined by theoretical calculations are given in dotted lines, with experimental determined bounds given in solid lines. Operating parameters and environmental conditions such as light intensity, chemistry selected, and robot geometry co-determine such bounds.

A large window of operating pressures is possible with at least some growing soft robots of the present disclosure, as indicated by the difference between the burst pressure and growing pressures, which spans nearly two orders of magnitude. This allows the robot to extend in environments with higher impedance (e.g. media such as loose soil), which require a higher operating pressure. Additionally, this pressure operating window can accommodate large extensions due to the small pressure gradient associated with transporting the low viscosity monomer solution. Growth is possible provided the pressure required for growth does not exceed the burst pressure of the tube being formed and an upper bound for total length can be estimated assuming increases in pressure to grow are solely derived from length increases and pressure drop due to fluid flow.

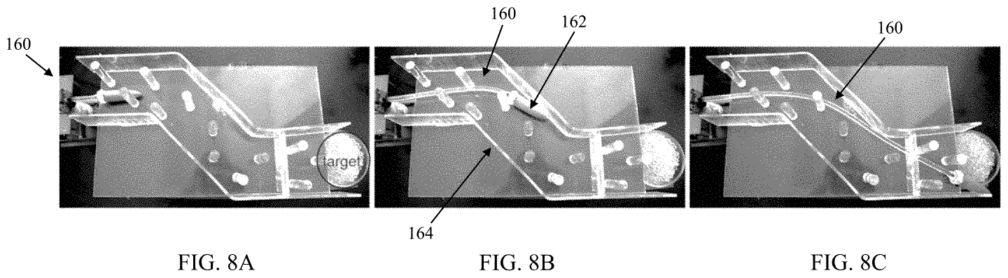

Some embodiments of the growing soft robots of the present disclosure demonstrate many of the capabilities of biological tip growth, for example passively navigating its environment, traversal of tortuous pathways, and movement in constrained environments. For example, the images of FIGS. 8A-8C reflect a growing soft robot 160 of the present disclosure (equipped with a nosecone 162) that is able to passively steer around obstacles and reach a desired destination along a constrained path 164. This capacity arises from the robot's inherent compliance, which permits it to conform to its environment and follow the path of least resistance.

By adding in an active steering system, the growing soft robots of the present disclosure are provided additional control over its navigation. In some non-limiting examples, the growing soft robots of the present disclosure can incorporate a secondary tube to turn the robot body (actuated by motors) in conjunction with a second curing step to hold the generated turn, fins or flaps to generate drag in a medium to direct the robot head, etc. In addition to use with soft robot applications, the curvature of the tube that is extruded can be controlled for making curved profiled parts as well as actively steering the robot. This can be accomplished by using a cable attached to some actuator on the robot's head at one end and to a flexible tube at the other. The flexible tube is held concentrically around where the cured polymer tube is extruded. When the cable is pulled by the actuator, this outer tube is bent and, in turn, bends the extruded photopolymer tube. This resultant curvature can be held by the extruded polymerized tube by, in some non-limiting examples, shining ultraviolet light on the curved extension by a ring of ultraviolet LEDs positioned along the outer, flexible tube.

As further explained in the Examples section, the growing soft robots of the present disclosure are, in some embodiments, able to navigate in high impedance environments, (e.g., soil). The growing soft robots of the present disclosure can, in some embodiments, exhibit a root-like ability to burrow through an impeded path while simultaneously generating a three-dimensional structure. Moreover, at a known monomer solution flow rate, sensing pressure deviations at the base of the growing soft robot, due to obstacles or changing environments encountered at the growing tip, can provide the growing soft robot a method to sense basic tip-environment interactions, resembling plant root stimuli response to changing soil impedance. This sensing can then be used to inform robot growth or to help map the environment through which it is travelling.

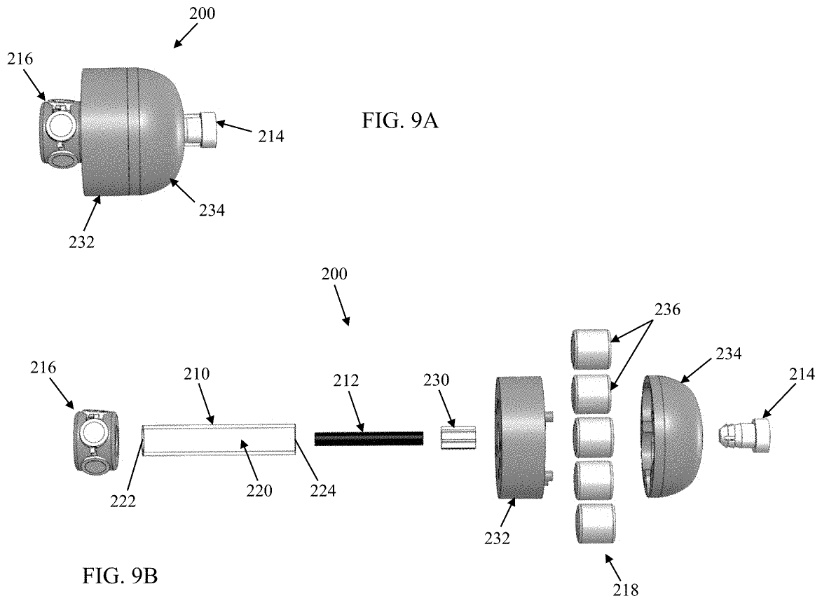

The ability to navigate tortuous pathways, exhibited by living organisms, has not yet been realized in a man-made tip growing system. Previously developed growing robots drag solid-state supply lines along with them. As such robots grow along tortuous paths, the force needed to drag these tethers increases exponentially. These limiting forces arise due to the friction between the solid material supply and the generated walls, which scales with moving contact area following Capstan equation behavior. By emulating the liquid-mediated transport principle seen in nature, the growing soft robots of the present disclosure can forgo the solid tether, for example with embodiments in which a battery or other power source is carried at the robot head, in favor of a liquid material supply circumventing this dominant source of friction. In this regard, FIGS. 9A and 9B illustrate one non-limiting example of a robot head 200 useful with the soft robots of the present disclosure and carrying or providing on-board power. The robot head 200 can be akin to the robot head 110 (FIGS. 5A and 5B), and includes an outer channel structure or tube 210, an inner tube 212, a plug or cover 214, an electromagnetic radiation source assembly 216, and a power source assembly 218 (referenced generally in FIG. 9B). Commensurate with the descriptions above, the outer channel structure 210 is formed of a material transparent or translucent to the radiation energy (e.g., UV light) from the electromagnetic radiation source assembly 216, and defines an open passageway 220 between opposing trailing and leading ends 222, 224 thereof. The inner tube 212 is formed of a material that blocks or shields radiation energy from the electromagnetic radiation source assembly 216 and defines an internal passage (hidden). The inner tube 212 is concentrically maintained with the outer channel structure 210 by a holder body 230 such that a channel is defined between the inner tube 212 and the outer channel structure 210. The plug 214 is assembled to the outer channel structure 210 at the leading end 224 in a manner that closes the passageway 220. The power source assembly 218 includes a base 232, a cap 234, and one or more batteries 236. The base 232 has a ring-like shape, and is configured to maintain the batteries 236. Further, the base 232 includes or carries appropriate electrical components (e.g., wiring, terminal(s), etc.) for electrically connecting the batteries 236 to the LED (or other electromagnetic radiation component) of the electromagnetic radiation source assembly 216 upon final assembly. The robot head 200 can function, as part of a growing robot, in manners similar to the robot head 110 as described above, with the power source assembly 218 powering the LEDs; with this and similar on-board power configurations, a separate power line or other tether to the robot head 200 is not necessary.

Embodiments and advantages of features of the present disclosure are further illustrated by the following non-limiting examples, but the particular materials, compositions and amounts thereof recited in these examples, as well as other conditions and details, should not be construed to unduly limit the scope of the present disclosure.

### EXAMPLES

E-SLIP extrusions and growing soft robots in accordance with principles of the present disclosure were constructed with systems and processes implicated by the E-SLIP methods described above. Thus, the following examples are useful in understanding both the E-SLIP features of the present disclosure, and the growing soft robot features of the present disclosure. The example E-SLIP processes as constructed and described below are reflected by the image of FIG. 3. The example growing soft robots as constructed are reflected by the images of FIGS. 6A-6C, 8A-8C, and corresponding descriptions. Further details on the example E-SLIP process, soft growing robots, and tests performed are provided below.

Materials

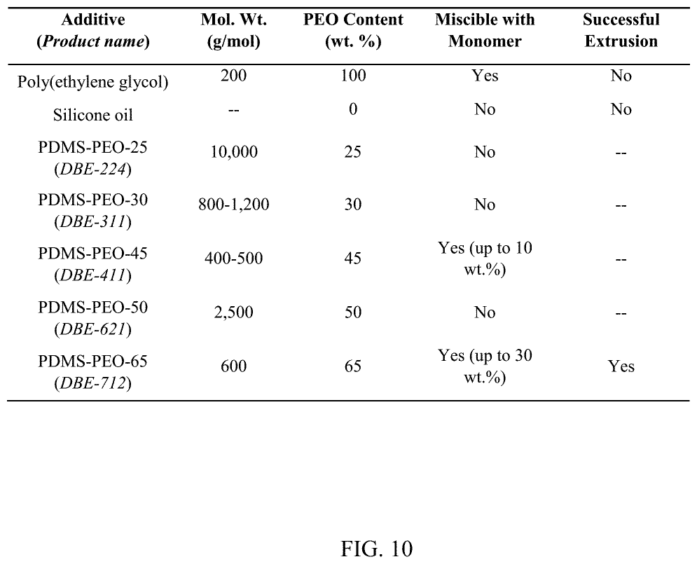

The example E-SLIP processes and growing soft robots utilized various materials. With these examples, materials employed include poly(ethylene glycol) diacrylate (PEGDA, MW=700 g/mol), pentaerythritol tetrakis(3-mercaptopropionate (PETMP), diphenyl(2,4,6-trimethylbenzoyl)phosphine oxide (TPO), propyl gallate, silicone oil, and mineral oil obtained from Sigma Aldrich and used as received. Pentaerythritol tetraacrylate (PETA) was obtained from TCI America and used as received. Poly(dimethylsiloxane)-poly(ethylene oxide) (PDMS-PEO) graft copolymers with varying molecular weights and poly(ethylene oxide) content (under the trade designations DBE-224, DBE-311, DBE-411, DBE-621, and DBE-712 and as reflected in the table of FIG. 10), and tridecafluoro-1,1,2,2-tetrahydrooctyl dimethylchlorosilane (DMCS) were obtained from Gelest, and used as received. Hydrophobic fumed silica (available under the trade designation Aerosil R812) was obtained from Evonik. Quartz and borosilicate glass tubes (outer diameter=9 mm, inner diameter=7 mm)) and fluorinated ethylene propylene (FEP) polymer tubing (outer diameter=4 mm, inner diameter=2 mm) were obtained from McMaster-Carr.

### Methods—Glass Channel Surface Treatment

In the examples, glass channels subjected to surface treatment were used. Quartz and borosilicate glass tubes were first treated in a base bath (isopropyl alcohol, potassium hydroxide, distilled water) for several hours to eliminate organic contamination, rinsed in distilled water, and then plasma treated in a Harrick Plasma cleaner (PDC-32G) for five minutes. The plasma-treated glass was then added to a 2 wt. % solution of tridecafluoro-1,1,2,2-tetrahydrooctyl dimethylchlorosilane (DMCS) in toluene to generate a fluorinated self-assembled monolayer and left in the solution for at least 24 hours, and then rinsed successively with isopropyl alcohol and distilled water, and heated in an oven for 2 hours at 120° C. before use. All extrusion and growing robot experiments utilized these fluorinated glass channels.

### Methods—Monomer Solution Preparation

In the examples, a thiol-ene based monomer solution was used. The thiol-ene based monomer solution consisted of a multi-functional acrylate component, poly(ethylene glycol) diacrylate (PEGDA, MW=700 g/mol) (for flexible resin) or pentaerythritol tetraacrylate (PETA) (for rigid resin), or blend thereof, combined with the tetra-functional thiol, pentaerythritol tetrakis(3-mercaptopropionate (PETMP), in a molar ratio of 8:5 acrylate to thiol groups. These monomers were combined in a scintillation vial with 0.15 wt. % photoinitiator (diphenyl(2,4,6-trimethylbenzoyl)phosphine oxide (TPO)) and a radical scavenger, propyl gallate, was added at 0.1-0.2 wt. % to act as a stabilizer, preventing premature polymerization of the thiol-ene monomer solution. To the monomer solution, 20 wt. % (unless specified otherwise) of the lubricating component, poly(dimethylsiloxane)-poly(ethylene oxide) graft copolymer (PDMS-PEO), was added and stirred for several minutes until completely dissolved. The thiol and acrylate component were then added and stirred until dissolved. For use in extrusion or the growing robotic device experiments, the monomer solution was transferred to a Luer-lock syringe. Selection of the lubricating component is described in greater detail below.

### Methods—Tensile Testing

In the examples, mechanical testing of various articles was performed. For mechanical testing, monomer solution was placed in Teflon molds shaped according to ASTM standard D1708 and exposed to ultraviolet (UV) light for 10 minutes at 20 mW/cm². Uniaxial tensile tests were conducted on a tensile tester (Instron 5966), equipped with a 500N load cell at a strain rate of 1 mm/min. The mechanical properties reported were the averages of at least three specimens.

### Methods—Fourier-Transform Infrared (FT-IR) Spectroscopy

In the examples, FT-IR spectroscopy analysis was performed at various stages. FT-IR spectroscopy was conducted with a Nicolet 6700 FTIR spectrometer (Thermo Fisher Scientific) with a KBr beam splitter, mercury cadmium telluride-A (MCT-A) detector. FT-IR spectra of liquid samples (PDMS-PEO, monomer solution, etc.) were obtained using an attenuated total reflectance (ATR) fixture. FT-IR spectrum of the lubricating layer was taken by wetting the ATR crystal with an extruded polymer tube with excess lubricating layer fluid originating from the tube exterior. The kinetics of the thiol-ene photopolymerization for the thiol-ene monomer solution were characterized by real-time FTIR scans using a customized horizontal transmission accessory, with UV irradiation generated using a mercury lamp UV light source (OmniCure S1500 Spot UV Light Curing System; Excelitas Technologies). Optically thin samples (˜20 μm) were prepared by placing monomer solution between two polished NaCl plates. Acrylate conversion (C_{acrylate}) was tracked by monitoring peak area change for the C═C peak (1630 cm⁻¹), normalized by the C═O peak (1702 cm⁻¹), which does not participate in the polymerization, which is represented by the equation:

$${C}_{acrylate} = 1 - \frac{{A}_{a c r y late} ( t )}{{A}_{a c r y late} ( t = 0 )} \qquad ( Eq . 1 )$$

Photopolymerization kinetics were assessed at several UV intensities (5, 10, 15, 30, and 100 mW/cm²), which were confirmed by a UV radiometer (Coherent FieldMaxII).

### Methods—Surface Energy and Contact Angle Measurements

In the examples, surface energy and contact angle measurements were obtained. Contact angle measurements were conducted on a Kruss DSA305 goniometer system. The static contact angle was measured to calculate the surface energy of materials in the tip growing setup with the two-liquid method using water and methylene iodide following Fowkes' theory as shown in Equations 2 and 3:

$$\sqrt{{γ}_{l 1}^{d} {γ}_{s}^{d}} + \sqrt{{γ}_{l 1}^{p} {γ}_{s}^{p}} = \frac{{γ}_{l 1} ( 1 + cos {θ}_{1} )}{2} \qquad ( Eq . 2 )$$

$$\sqrt{{γ}_{l 2}^{d} {γ}_{s}^{d}} + \sqrt{{γ}_{l 2}^{p} {γ}_{s}^{p}} = \frac{{γ}_{l 2} ( 1 + cos {θ}_{2} )}{2} \qquad ( Eq . 3 )$$

where y is either the surface tension or energy of materials, subscript l1,l2 ands denote the two testing liquid used (1 for water and 2 for methylene iodide) and the surface of interest, the superscript d and p stand for the disperse and polar component of the surface tension or energy of materials, and finally θ₁ and θ₂ is the static contact angle of water and methylene iodide on the surface of interest.

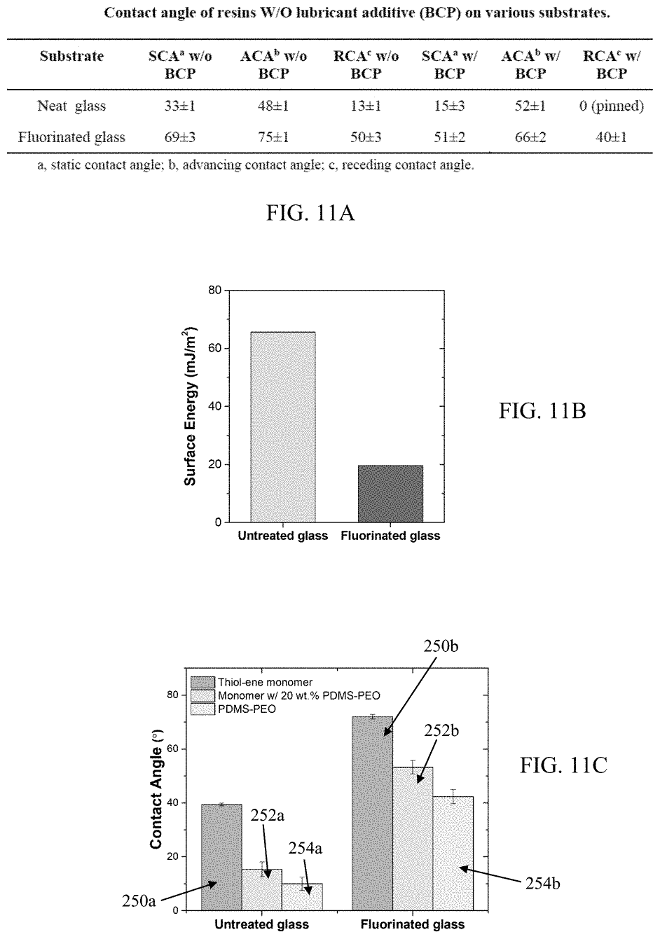

Advancing and receding contact angles were also measured to better characterize the wettability of glass surface by the working liquid resin. The advancing contact angle was measured during the process of slowly increasing the volume of a standing droplet from 3 to 10 μL. The receding contact angle was measured during the slow withdrawal of liquid from a standing droplet with an initial volume of 15 μL. The data were collected from three positions within the cross section for each sample and were averaged over three samples. The results of surface energy and contact angle measures are summarized by the Table of FIG. 11A and the graphs of FIGS. 11B and 11C. The data of FIG. 11C indicates the determined contact angle for the thiol-ene monomer 250a, the monomer with 20 wt. % PDMS-PEO 252a, and the PDMS-PEO 254a with untreated glass, and the determined contact angle for the thiol-ene monomer 250b, the monomer with 20 wt. % PDMS-PEO 252b, and the PDMS-PEO 254b with flourinated glass.

### Lubricant Selection

Studies were performed to evaluate surface energy and lubrication design. The surface energies of surfaces in contact have a large effect on chemical adhesion experienced. Thus the surface energy of the glass channel walls was reduced substantially (e.g., as implicated by FIG. 11B) by treating with a fluorosilane (DMCS), through generation of a fluorinated self-assembled monolayer on the glass surface. However, thiol-ene monomers photopolymerized in a fluorinated channel were found to still suffer from substantial adhesion, likely due to mechanical adhesion effects. A non-reactive lubricating constituent was added to the monomer resin to introduce a liquid lubricating layer at the interface in an attempt to eliminate solid-solid contacts and any chemical bonding. To achieve this, the inventors of the present disclosure determined that the liquid lubricant should be miscible with the monomer resin (to allow for light penetration through the sample during extrusion) and preferentially adsorb at the interface. Several potential lubrication additives were screened (summarized in the table of FIG. 10), with a PDMS-PEO block copolymer (with 60 wt. % PEO) selected as the lubricant additive, due to its substantial miscibility with the monomer resin. The ability of the PDMS-PEO block polymer to accumulate at the interface is in part due to its enhanced wetting over the monomer resin (implicated by FIG. 11C), with a lower contact angle than the monomer resin on untreated and treated glass. This accumulation at the interface was found to continue after extrusion of the part, with PDMS-PEO migrating to the polymer-air interface and generating a thin liquid film on extruded parts.

### Lubricating Layer Measurement

Indirect measurement of the lubricating layer (i.e., at the interface with the glass channel surface) was conducted by measurement of the photopolymer tube diameter after extrusion using a DHR-3 (TA Instruments) rheometer with a 25 mm parallel plate geometry, due to the extensible nature of the photopolymer tubes. Plates were lowered until a non-zero axial force (>0.2 g) was measured, with the gap at this point taken as the outer diameter of tube. The approximate average lubrication layer thickness (L_{lubricant}) was then inferred from the tube outer diameter (d_{tube}) and the glass channel inner diameter (d_{glass}, inner), by the following equation, which assumed a uniform lubrication layer:

$${L}_{lubricant} = \frac{{d}_{g l ass , inner} - {d}_{t u b e}}{2} \qquad ( Eq . 4 )$$

### Shear Rheology

In the example descriptions, reference is made to shear rheology. All rheology tests were conducted with a rotational rheometer (available under the trade designation DHR-C from TA Instruments). Shear rheology of the simulated soil was conducted using the rotational rheometer with a 25 mm parallel plate geometry. A Peltier plate was used for temperature control and held at 25° C. Oscillatory amplitude sweeps were conducted at 1 Hz from 0.1-500 Pa in oscillatory stress. Shear rheology of the monomer solution containing 20 wt. % PDMS-PEO was conducted using the rotational rheometer with a 40 mm cone and plate geometry. A Peltier plate was used for temperature control and held at 25° C. Shear rate sweeps were performed from (0.1 to 100 Hz). Axial force was maintained at 0 N during photopolymerization and the gap was allowed to change. The linear shrinkage of the resin was estimated using changing gap using the following equation:

$${L}_{Lubriant} = \frac{{d}_{g l ass , inner} - {d}_{t u b e}}{2} \qquad ( Eq . 5 )$$

### E-SLIP Set-Up and Examples

With additional reference to FIG. 3, the E-SLIP set-up consisted of the following main elements: a programmable syringe pump (Harvard Apparatus PhD Ultra), connective tubing (Tygon, outer diameter= 3/16 in.), and transparent channel with light source for photopolymerization. The channel was made up of the fluorinated quartz tube, containing within it an annular region, composed of a UV-blocking fluorinated ethylene propylene (FEP, McMaster-Carr) tube held in place concentrically with an additively manufactured custom holder (Clear resin on Formlabs 1+). During extrusion, this FEP tube was plugged to prevent flow within. The light source was composed of six concentric UV light-emitting diodes (Chanzon, =380 nm, 3 W, 6 mm lens diameter), which surrounded the surface-treated quartz tube and were masked to allow a 5 mm window of light to reach the glass tube through an additively manufactured housing (made with Tough 2000 resin on a Form 3 3-D printer or PLA on a MakerBot Replicator 2). Flow rate was set and recorded through the status monitor on the syringe pump and pressure data was monitored through an electronic pressure sensor (0-206.84 kPa(30 psi) Honeywell TBP series, vented gauge) positioned at a three-way tubing junction near the monomer injection port at the base. Silicone oil was used as an immiscible buffer fluid between the monomer solution and pressure sensor to prevent premature sensor failure. These sensors were connected to a custom data acquisition (DAQ) circuit, with a microcontroller (Teensy 4.0) coded to control and record the cameras, UV LEDs, and sensors.

To conduct extrusion of a solid body through E-SLIP, a Luer-lock syringe was loaded on the syringe pump and mated with the connective tubing. With annular body extrusions, a UV-opaque cylinder was added, held concentrically within the glass channel by a custom-made 3-D printed o-ring. Monomer was initially supplied to fill the channel, oriented vertically, up to the point of the UV LEDs. Extrusion was initiated by starting flow of monomer (at a constant flow rate) through the syringe pump and supplying power to the UV LEDs.

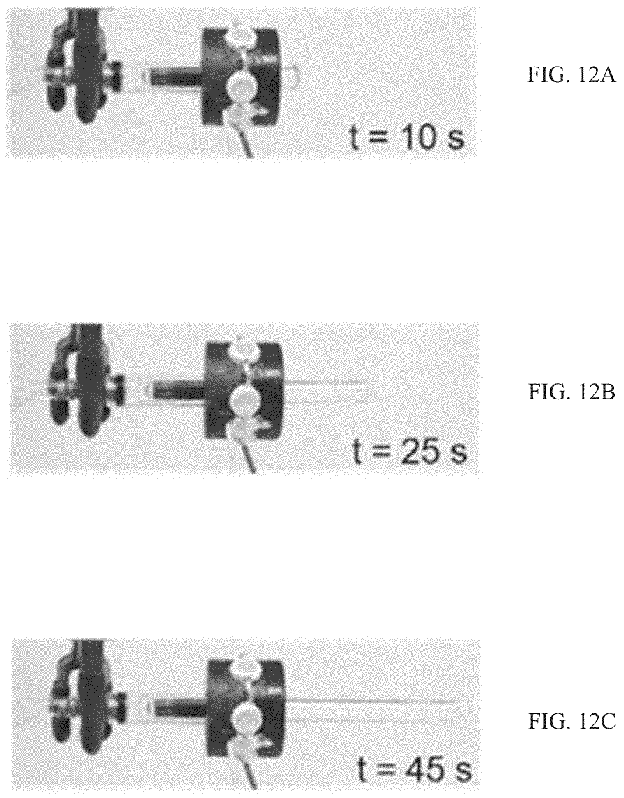

A number of extrusion examples were formed using the E-SLIP techniques. Photographs of one example E-SLIP extrusion (corresponding with the explanations above with respect to FIG. 3) over time is shown in the photographs of FIGS. 12A-12C and reflect extrusion of a polymer tube using a monomer solution containing 20 wt. % PDMS-PEO delivered at a constant flow rate.

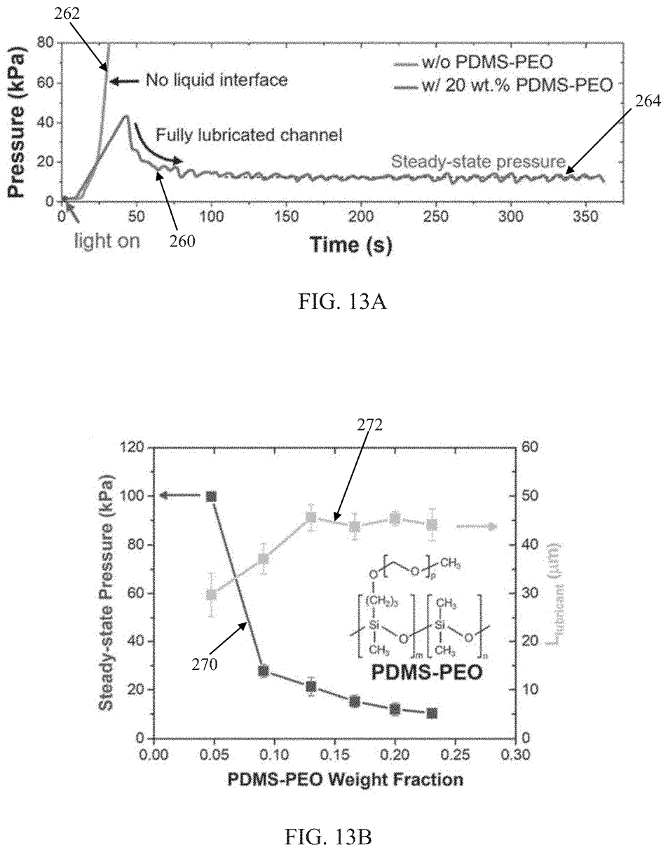

Additional E-SLIP extrusion examples were performed using the arrangement of FIG. 3 and monomer solutions prepared with various concentrations of PDMS-PEO extruded at a constant flow rate. Fluid pressure was measured simultaneously during extrusion to probe adhesion and friction at the channel-polymer interface. FIG. 13A reports example fluid pressure measurements for extrusion of a monomer containing 20 wt. % PDMS-PEO (plot line 260) and for extrusion of a monomer without any PDMS-PEO (plot line 262), with time averaged pressure shown as dotted line 264. As shown, the fluid pressure remains constant prior to UV LED illumination. After illumination, the fluid pressure rapidly rises, likely due to initial static friction between the initially formed photopolymer and channel. In the case of extrusion with 20 wt. % PDMS-PEO in the monomer solution (plot line 260), the fluid pressure decreases to a steady-state value, as the cured photopolymer tube exits the channel. The inventors of the present disclosure have surmised that this characteristic coincides with a fully developed lubrication layer (˜30-45 μm) at the interface which conforms to the geometry of the channel. The inventors of the present disclosure noted that the fluid pressure fluctuates during steady-state extrusion, which is consistent with slip-stick phenomena. However, without PDMS-PEO in the monomer solution (plot line 162), no lubrication layer is formed and adhesion between the wall and polymer is significant enough to prevent extrusion, as the fluid pressure continues to rise until device failure.

With reference to FIG. 13B, additional E-SLIP extrusion examples performed with various concentrations of PDMS-PEO in the monomer solution revealed that by increasing the PDMS-PEO content in the monomer solution, the steady-state extrusion pressure can be substantially reduced (plot line 270), and the inferred thickness of the lubricating layer (L_{Lubncant}) increased (plot line 272). As a point of reference, FIG. 13B provides an example of steady-state pressure required to extrude an annular tube of photopolymer and thickness of lubrication layer formed with respect to varying weight fractions of PDMS-PEO block copolymer in the monomer solution as a lubricating agent, at a flow rate of 1 mL/min.

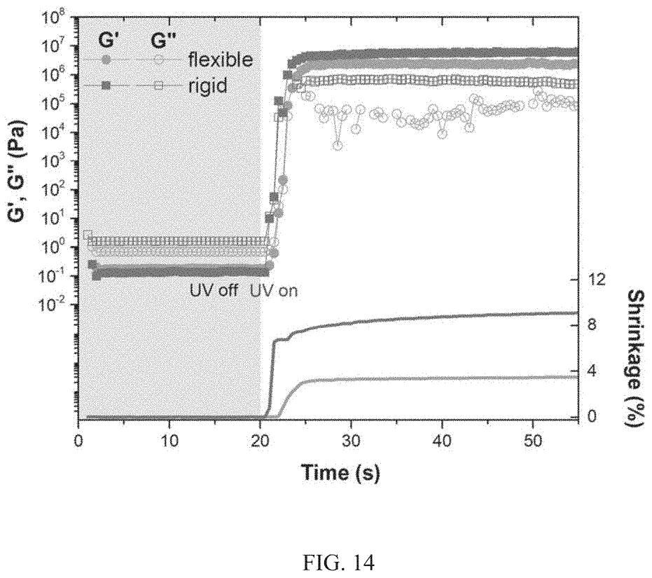

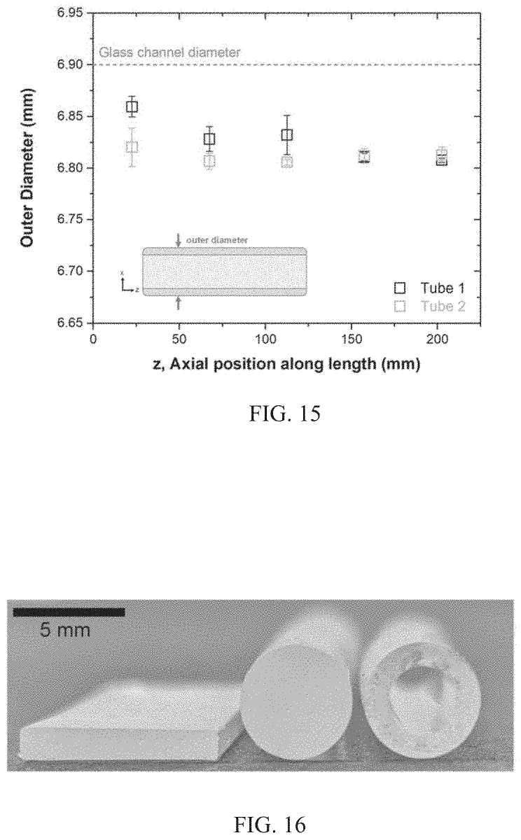

Through various E-SLIP extrusions, the inventors of the present disclosure discovered that by confining solidification inside the channel and using low shrinkage resins (as identified in FIG. 14), excellent dimensional fidelity to the channel geometry was observed, with the channel geometry dictating the final shape. FIG. 15 reports the average outer diameter of extruded tubes as a function of axial length for two of the example tube extrusions. This allows the structure to be templated and then generated fully before removal from the supporting channel. Moreover, by changing the geometry of the channel, a variety of profiled shapes were generated beyond the tube structure. For example, FIG. 16 is a photograph of several example extrusions produced by the E-SLIP process, including rectangular, cylindrical and annular cross-sections.

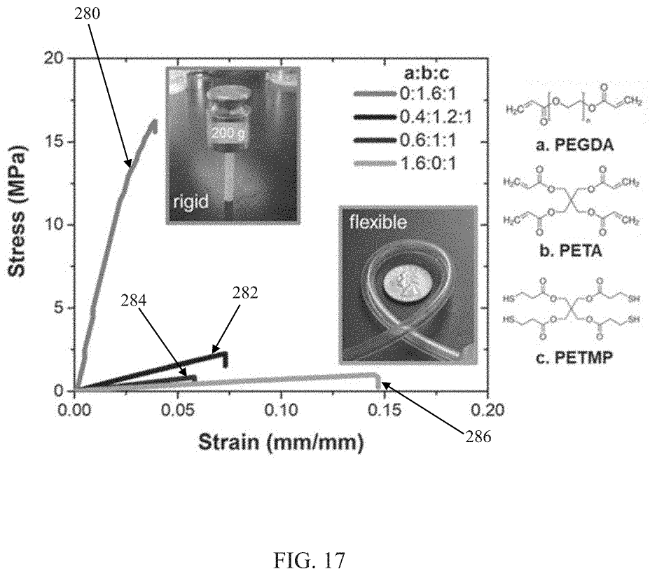

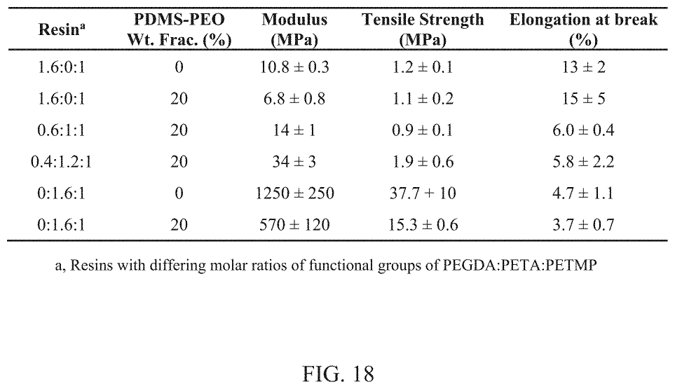

Additional example E-SLIP extrusion objects or structure were formed using monomer solutions with differing molar ratios of the two acrylate components in the monomer solution (i.e., using resins with differing molar ratios of functional groups of PEGDA:PETA:PETMP). FIG. 17 reports the mechanical properties of the so-extruded example solid bodies using a thiol-ene resins containing 20 wt. % PDMS-PEO and a PEGDA:PETA:PETMP ratio of 0:1.6:1 (plot line 280), 0.4:1.2:1 (plot line 282), 0.6:1:1 (plot line 284), and 1.6:0:1 (plot line 286). As shown, E-SLIP was found to be able to fabricate robust parts with elastic modulus (E) spanning two orders of magnitude (from 7 to 570 MPa), through modulation of the molar ratio of two acrylate components in the monomer solution. By way of comparison, extrusions were also performed utilizing monomer resins without the 20 wt. % PDMS-PEO block co-polymer, and in particular a resin with a PEGDA:PETA:PETMP ratio of 1.6:0:1 and 0:1.6.1. The mechanical properties of the example and comparative example extrusions are summarized in the table of FIG. 18. The inventors of the present disclosure have surmised that E-SLIP is likely to be compatible with other chemistries, expanding the design space of possible functional monomers and block copolymers

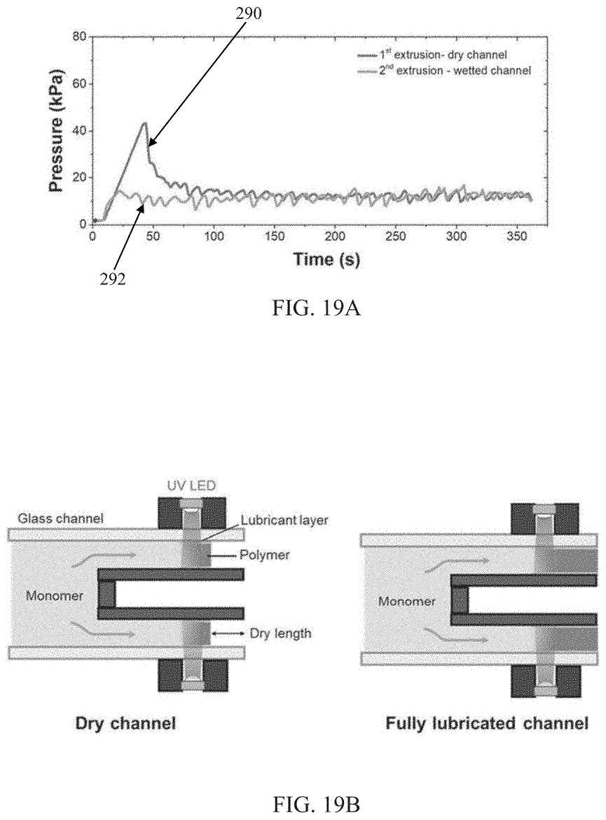

From the above examples, studies were preformed to evaluate pressure behavior as a function of time in extrusion. The fluid pressure was measured as a function of time during extrusion. Typical pressure-time curves during the E-SLIP extrusion in a “dry” (unwetted with PDMS-PEO) channel are displayed by plot line 290 in FIG. 19A. As a point of reference, in the graph of FIG. 19A, the first extrusion (plot line 290) was conducted in a cleaned, dry channel and features a large rise in the initial pressure in forming the lubrication layer. The subsequent extrusion (plot line 292) occurred in an already wetted channel with the previous generated tube removed, with the fluid pressure reaching steady-state likely due to residual lubricant layer at the interface. The pressure first rises linearly at the beginning of extrusion, then reduces to a much lower but constant value with small fluctuations. The initial linear increasing of pressure is partly attributed to the static friction between the newly formed tube and channel. Additionally, it was observed that the pressure still rose despite the movement of the initially formed tube and that the time when the pressure value peaked typically coincided with the moment the tube exited the channel. These observations indicate that the duration and magnitude of the initial rise in pressure is related to the ‘dry’ length of the channel, i.e., the unlubricated distance between the UV illumination window and the end of the channel prior to the E-SLIP extrusion, as illustrated in FIG. 19B (that otherwise schematically depicts extrusion in dry channel, with a ‘dry’ length that must be fully lubricated to reach continuous extrusion at a steady-state pressure). The dynamic friction between the moving tube and channel is directly related to the establishment of a wetting layer, hence the longer the ‘dry’ distance, the higher the peak pressure value. This was confirmed by the pressure versus time plot from an extrusion with a pre-wetted channel from a previously run extrusion, demonstrating both a lower peak pressure value and a shorter peak time (FIG. 19A). Once a wetting layer establishes, the extrusion pressure reduces and fluctuates about a constant value.

### Growing Robot Set-Up and Hardware

Example growing soft robots were constructed and evaluated. The growing robot process utilized the same hardware used in extrusion as above. With additional reference to FIGS. 6A-6C, the robot head consisted of the glass channel with an unplugged FEP inner tube, UV LEDs and housing, and an additively manufactured end plug (made with Flexible 80A resin on a Formlabs Form 3 printer). A short length (˜5 cm) of previously extruded photopolymer tube was used as the connection between the robot head and the connective tubing extending from the syringe, held in place with plastic snap-grip clamps and a tapered plastic tubing connector. The polymer tube and robot head were filled with monomer in a vertical orientation to eliminate air bubbles from the tube and channel. The end plug was inserted in the channel to fully seal the channel. Growth could then be started by the simultaneous flow of monomer from the syringe and powering of UV LEDs

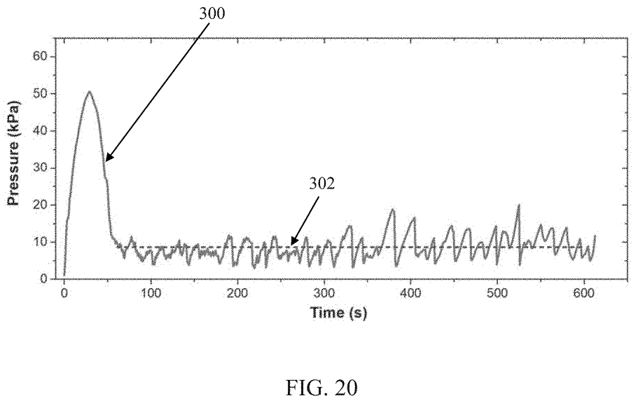

FIG. 20 reports pressure data for the example growing soft robot. Fluid pressure was measured (plot line 300) during a growing robot experiment with a flow rate of 1 mL/min. A time-averaged steady state pressure is identified in FIG. 20 with a dotted line 302. As shown, there was an initial rise in pressure and then a decline to a steady-state value.

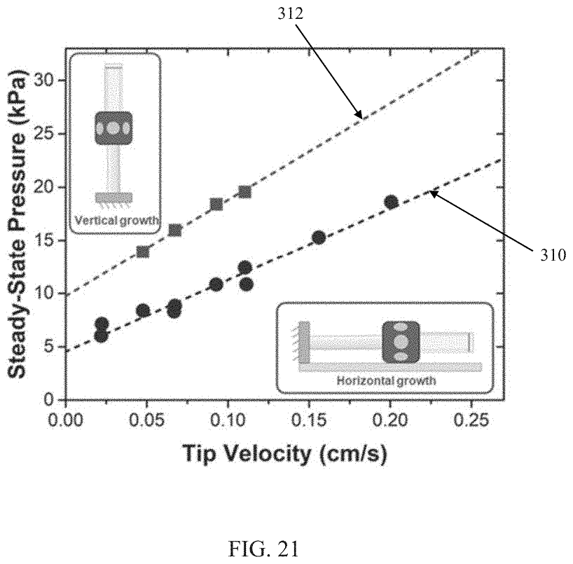

To elucidate the growing behavior of the growing soft robot shown in FIGS. 6A-6C, the fluid pressure was measured during robot lengthening with the monomer solution driven at a constant flow rate. This fluid pressure behavior was found to resemble the behavior observed in the extrusion setup (i.e., described above with reference to FIG. 13A), with an initial rise in pressure and then declines to a steady-state value. Tip velocity (i.e., velocity of the robot head) was also measured. FIG. 21 presents measured pressure behavior as a function of tip velocity for example growing soft robots in two different directions, horizontal (plot line 310) and vertical (plot line 312). This pressure increases linearly with the robot tip velocity, which is directly proportional to the liquid monomer flow rate, with a minimum pressure extrapolated to zero velocity as shown. The positive linear velocity dependence of the extrusion pressure is a characteristic of hydrodynamic friction, originating from the lubricant layer between the confining channel and solidified polymer. In other words, the bulk of the pressure to grow can be attributed to overcoming the friction at the interface, not the pressure drop due to fluid flow through the body and the robot head. The minimum pressure is attributed to the resistive forces that are overcome during growth: the internal friction between the polymerized tube and the channel walls and the external resistance between the robot head and the environment. The internal friction, as reflected in the steady-state pressure, is reduced with increasing PDMS-PEO concentration, consistent with previous results described above (e.g., FIG. 13B). When switching the direction of growth from horizontal to vertical, an upward shift in the pressure-velocity relationship was observed, attributed to an increase in external resistance due to the weight of the robot head (˜15 g).

From the above examples, studies were performed to validate robot velocity. To verify that the flow rates imposed by the syringe pump were being realized in the growing robot, a comparison between the expected velocity and the average experimental velocities was conducted. The theoretical average growing robot velocity is determined by the following equation:

$${v}_{robot , avg} = \frac{Q}{{A}_{t o t a l}} \qquad ( Eq . 6 )$$

where Q is the volumetric flow rate imposed by the syringe pump and Aₜₒₜₐₗ is the total cross-sectional area of the tube, which includes both the annular region of photopolymer tube and inner monomer fluid region. This cross-sectional area determines robot velocity because for every new volume of photopolymer tube that is generated, there must be a matching volume of monomer fluid in the interior of tube to ensure fluid continuity within the device

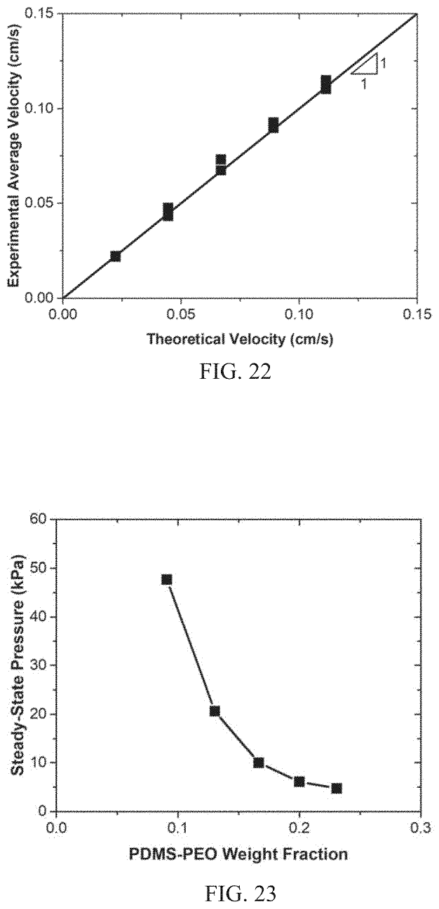

The experimental average velocities were determined by manually measuring the length of photopolymer tube generated and dividing it by the total experimental time. This results in the average robot velocity for the entire experiment. The comparison between these experimental and theoretical robot velocities across several imposed flow rates (reported in FIG. 22), showing approximate agreement between the two.

From the above examples, studies were performed to evaluate the effect of PDMS-PEO in lubricating the growing robot. The effect the concentration of the PDMS-PEO block polymer on the pressures required for growth using the flexible thiol-ene resin was investigated to see the effect of lubrication on the lengthening of the growing robot. The results are reported at FIG. 23. A qualitatively similar trend is seen in the growing robot (i.e., FIG. 20) as compared to lubrication with PDMS-PEO in E-SLIP in the extrusion setup (i.e., FIG. 13A), with substantial early reductions in the pressure required for growth with increasing PDMS-PEO content.

From the above examples, studies were performed to evaluate burst pressure of example growing soft robots. The maximum pressure that the system can handle was calculated as the burst pressure of the extruded tube. To accomplish this, hoop and radial stresses were calculated using Lame's equations for thick walled cylinders (Equation 7 below):

$${σ}_{hoop} = \frac{{r}_{i}^{2} {P}_{i} - {r}_{o}^{2} {P}_{o}}{{r}_{o}^{2} - {r}_{i}^{2}} + \frac{( {P}_{i} - {P}_{o} ) {r}_{i}^{2} {r}_{o}^{2}}{( {r}_{o}^{2} - {r}_{i}^{2} ) {r}^{2}} , {σ}_{radial} = \frac{{r}_{i}^{2} {P}_{i} - {r}_{o}^{2} {P}_{o}}{{r}_{o}^{2} - {r}_{i}^{2}} - \frac{( {P}_{i} - {P}_{o} ) {r}_{i}^{2} {r}_{o}^{2}}{( {r}_{o}^{2} - {r}_{i}^{2} ) {r}^{2}} \qquad ( Eq . 7 )$$

Along with these, an additional compressive stress was included from the fluid pressure on the forward end of the extruded tube (Equation 8 below):

σₐₓᵢₐₗ=−Pᵢ (Eq. 8)

Based on the stress-strain curves of the two explored photopolymer chemistries (FIG. 17), the flexible composition was treated as a ductile material and the rigid composition was treated as a brittle material based on the criteria that a failure strain under 5% is brittle and above 5% is ductile. To determine the maximum allowable pressure for the flexible chemistry, the stresses were combined using von Mises theory. This was then set equal to the flexible polymer's yield stress and the internal pressure was solved for Equation 9 below:

$${σ}_{v m} = \frac{1}{\sqrt{2}} \sqrt{{( {σ}_{hoop} - {σ}_{radial} )}^{2} + {( {σ}_{radial} - {σ}_{axial} )}^{2} + {( {σ}_{axial} - {σ}_{hoop} )}^{2}} , {σ}_{v m} \geq {σ}_{y} \qquad ( Eq . 9 )$$

To determine the maximum allowable internal pressure for the rigid photopolymer, modified Mohr's failure theory was used with the hoop stress being the dominant stress component. This was then set equal to the rigid chemistry's yield stress and the internal pressure was solved for Equation 10 below:

σₕₒₒₚ=S_{u,t} (Eq. 10)

Here σₕₒₒₚ, σ_{radial}, and σₐₓᵢₐₗ are the hoop, radial, and axial stresses respectively. Pᵢ and rᵢ are the internal pressure and inner radius, Pₒ and rₒ are the external pressure and outer radius, and r is the radial position where the stress is calculated. In the above equations, σᵥₘ is the von Mises stress σ_{y} is the yield stress of the flexible chemistry and S_{u,t} is the ultimate tensile stress of the rigid chemistry. The dimensions used in this calculation do not include the lubrication layer thickness which accounts for ˜1% of the tube radius.

From the above examples, studies were performed to evaluate maximum robot length. As the tip of the unimpeded robot grows at a constant speed (implying constant pressure at the tip), there would be increases in pressure at the base (where monomer solution is supplied) over time due to the frictional losses of pumping a viscous fluid in a pipe of increasing length. Assuming all pressure increases after reaching steady-state growth stem from these frictional losses, a determination of the resulting maximum length of the robot can be made, which would occur when the operating pressure reaches the burst pressure of the polymer tube near the base. This is done by isolating the two pressure components required for robot locomotion: the pressure required for growth at the tip (P_{growth}) and the pressure to transport monomer from the base of the robot along its body to the growing tip (P_{transport loss}), and setting them equal to the burst pressure (Equation 11 below):

P_{burst}=P_{growth}+P_{transport loss} (Eq. 11)

The fluid pressure can be approximated by Poiseuille flow in a pipe, which is governed by Equation 12:

$${P}_{transport loss} = \frac{8 η L Q}{π {R}^{4}} \qquad ( Eq . 12 )$$

where η is the monomer solution viscosity, L is the pipe length, Q is the volumetric flow rate, and R is the pipe radius. The pressure gradient, or additional pressure for transport required per unit length, can be found by taking the derivative of Equation 12 with respect to length. By combining Equations 11 and 12, and solving for length, an expression for the maximum length dictated by Poiseuille loss can be obtained by Equation 13 below:

$${L}_{max , Poiseuille} = \frac{( {P}_{b u r s t} - {P}_{g r o w t h} ) π {R}^{4}}{8 η Q} \qquad ( Eq . 13 )$$

As an example, using a flow rate used in this work (Q=1 mL/min), the dimensions of the generated tube (R=2 mm), viscosity of the monomer solution (0.05 Pa·s), and the P_{burst} (512 kPa) and P_{growth} (8 kPa) for the PEGDA-based monomer resin yields a theoretical of 3,800 m.

From the above examples, studies were performed to evaluate photopolymerization kinetics and upper velocity modeling. The inventors of the present disclosure determined that the growing mechanism may require that a complete annular cross-section become photopolymerized by the end of the illuminated region to prevent leakage of monomer. Some deviation along the inner or outer annular radii may be tolerated, resulting in a lower conversion and reduced mechanical properties. However, any deviation such that a part of the annular cross-section is not solidified could result in leakage that could catastrophically disrupt further extrusion or growth. Assuming a constant velocity profile, all monomers are exposed to UV light for the same amount of time. The timescale of photopolymerization can be captured in the gel time, which is the time required to reach the point of the liquid-solid transition. Past the gel point, the polymer network would be able to bear load and prevent monomer leakage. Thus, if the residence time of monomer in the illuminated region is less than the gel time, photopolymerization will not occur. However, gel times are not the same across the annular channel due to light attenuation through the channel width. The limiting photopolymerization timescale of interest for a growing soft robotic device operation is the gel time at the channel wall opposing the light source. Given these conditions, the maximum velocity achievable by the growing robot before failure is given by:

$${v}_{max} = \frac{{d}_{l i g h t}}{{t}_{g e l}} \qquad ( Eq . 14 )$$

where d_{tight} is the lengthscale of the illuminated region and t_{gel} is the gel time of the monomer fluid at the channel side farthest from the UV light source. Due to attenuation of light intensity in the monomer solution, the gel time varies radially, with monomer furthest from the light source demonstrating the highest gel time and thus is the limiting timescale for growth. Therefore, the maximum tip velocity is also dependent on thickness of the channel used, with thicker channels having a reduced maximum tip velocity. To determine the gel time as a function of channel depth, the simulated UV intensity decay as a function of depth was calculated according to a Beer-Lambert relation:

I(z)=I₀ (10^{-∈[PI]r}) (Eq. 15)

Where I₀ is the incident light intensity at the channel wall nearest to the light source, ϵ is molar absorptivity of the photoinitiator, [PI] is the concentration of photoinitiator, and r is the radial position from the light source. The molar absorptivity for the photoinitiator TPO was determined to be 60 m²/mol and the initial intensity of the UV LEDs determined by radiometer to be approximately 12 mW/cm². Light attenuation based on the introduced version Beer-Lambert law assumes that the photoinitiator is the main source of light absorption and that the light absorption does not change much with time.

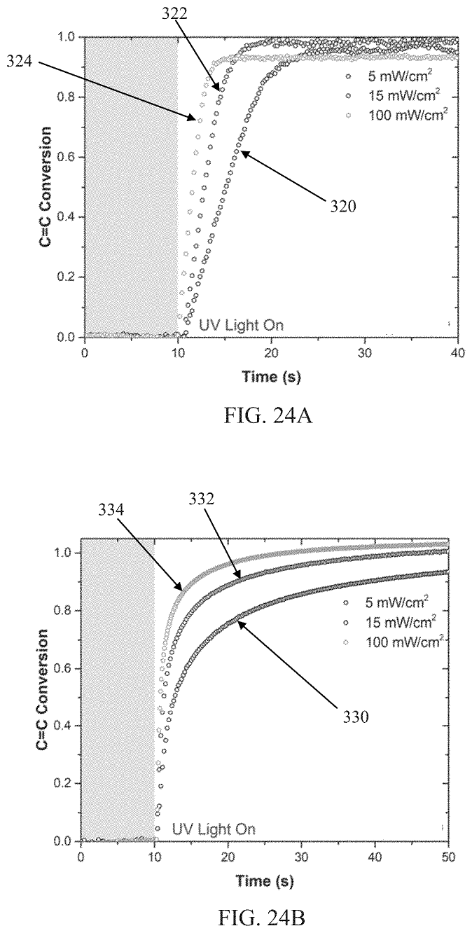

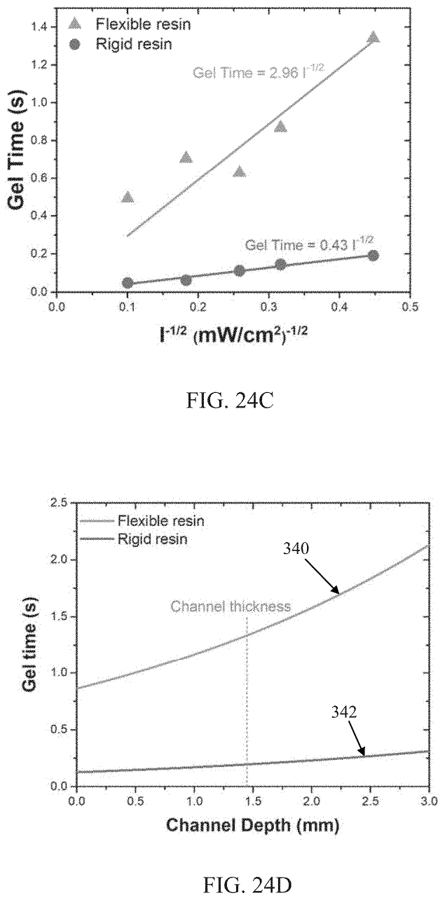

To ascertain the gel time as a function of channel depth, the photopolymerization kinetics were characterized via real-time FTIR to generate conversion curves of the thiol and acrylate group during photopolymerization at several different UV intensities. Thiol-acrylate polymerizations are known to undergo mixed chain and step growth polymerizations and Eq. 16 developed by Reddy et al., allows for the calculation of the gel point in terms of acrylate conversion:

$$\frac{2}{r} ( {f}_{acrylate} - 1 ) \frac{{k}_{C C}}{{k}_{C S}} {p}_{α} + ( {f}_{acrylate} - 1 ) ( {f}_{t hiol} - 1 ) ( 1 + \frac{2}{r} \frac{{k}_{C C}}{{k}_{C S}} ) {p}_{α}^{2} = 1 \qquad ( Eq . 16 )$$

where r is the stoichiometric ratio between S—H and C═C functional groups, f_{acrylate} and fₜₕᵢₒₗ are the acrylate and thiol monomer functionalities, respectively, and k_{CC}/k_{CS} is the ratio of the propagation constant for the acrylate homopolymerization to the chain transfer constant for the thiol-acrylate reaction. Previous literature has demonstrated that k_{CC}/k_{CS}=1.5 for thiol-acrylate photopolymerization. The conversion at the gel point was determined to be 0.06 and 0.16 for the elastic and rigid thiol-acrylate resins, respectively. Gel times for each resin were determined for each different UV intensity, by a linear fit in the low conversion regime to find both the initial time at zero conversion and time at gel point, with the gel time the difference of the two, and are reported at FIGS. 24A and 24B. As a point of reference, FIG. 24A represents acrylate conversion of flexible resin with 20 wt. % PDMS-PEO during photopolymerization at several UV intensities, with linear fits in the low conversion regime to determine gel times. Data points 320 reflect measurements obtained at 5 mW/cm², data points 322 reflect measurements obtained at 15 mW/cm², and data points 324 reflect data measurements obtained at 100 mW/cm². FIG. 24B represents acrylate conversion of rigid resin with 20 wt. % PDMS-PEO during photopolymerization at several UV intensities, with linear fits in the low conversion regime3 to determine gel times. Data points 330 reflect measurements obtained at 5 mW/cm², data points 332 reflect measurements obtained at 15 mW/cm², and data points 334 reflect data measurements obtained at 100 mW/cm². The films used in the FTIR study were approximately 20 in thickness and were treated as an adequate approximation for photopolymerization kinetics at zero thickness, due to negligible light intensity differences throughout the thickness.

It has been previously demonstrated that the gel times should scale with I^{-1/2} in a thiol-acrylate photopolymerizations. Gel times were plotted as a function of I^{-1/2}, shown in FIG. 24C, yielding approximate linear fits and a resulting empirical relationship between gel time and UV intensity. Combining Equation 16 with the linear fits yielded a relationship between depth and gel time for each distinct resin, shown in FIG. 24D (where plot line 340 represents the flexible resin, and plot line 342 represents the rigid resin), which allows for determination of t_{gel} and therefore vₘₐₓ, which were calculated to be 22.2 cm/min and 154 cm/min for the flexible and rigid resins, respectively.

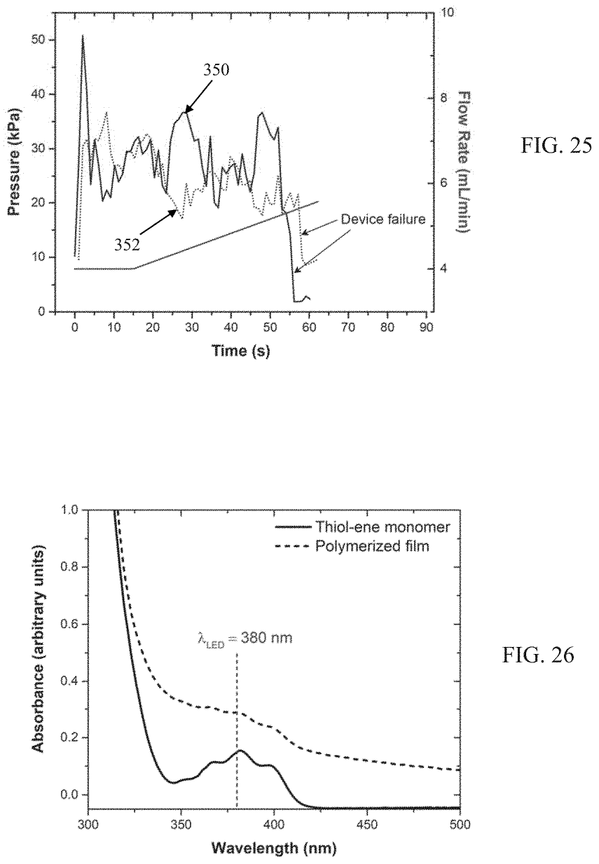

The upper velocity limit was also determined experimentally by linearly increasing the flow rate and associated robot velocity until device failure due to incomplete photopolymerization. The results of these experiments are provided in FIG. 25. Flow rates were linearly increased by 2 ml/min² to modulate robot velocity while the fluid pressure was measured, with two separate trials shown in solid and dotted lines (plot lines 350 and 352). The decrease in fluid pressure demonstrates device failure due to incomplete curing of the photopolymerized tube, leading to monomer leakage. Experimental maximum velocities were calculated from the imposed flow rates at the point of tube failure according to Eq. 14.

From the above examples, studies were performed to evaluate light absorption in monomer solution and photopolymerized film. In the maximum velocity model, there is an assumption that absorption does not vary substantially during photopolymerization and the photoinitiator is the main source of absorption. However, while these assumptions are not rigorously met, as there is increased light attenuation in the photopolymerized film, the model does appear to capture dominant variables that influence photopolymerization and their scaling. FIG. 26 reports the results of UV-visible absorption spectra of thiol-ene monomer and photopolymerized film. The polymerized film demonstrates increased absorption as compared to the thiol-ene monomer solution. This increase in absorption would result in further light attenuation during photopolymerization, leading to overestimation of the maximum theoretical velocity.

### Growing Soft Robots—Tortuous Path

Tests were performed top evaluate an ability of the growing soft robots to traverse a tortuous path. The images of FIGS. 8A-8C reflect the results of one such test, and illustrate that the growing soft robot successfully self-manipulated about various obstacle in generating a tortuous path.

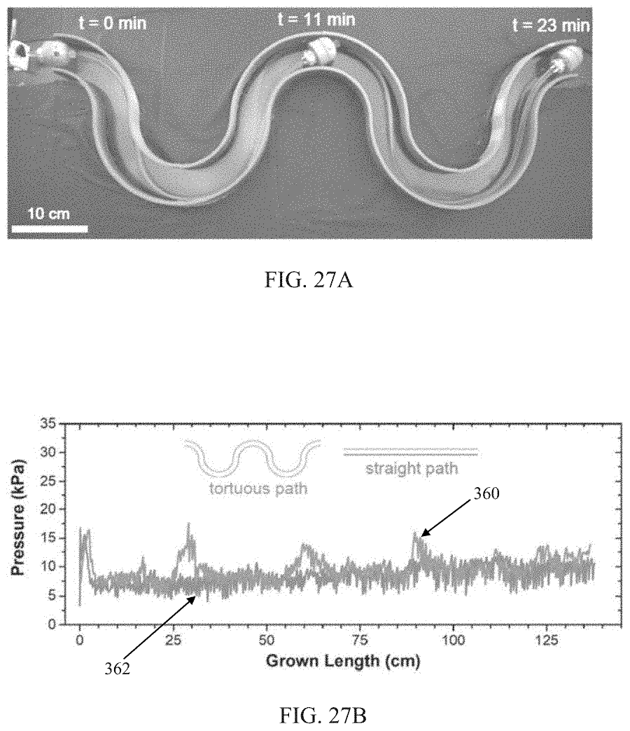

The time-lapse images of FIG. 27A reflect another example growing soft robot that was found to be able to traverse a tortuous path, whereas FIG. 27B reports the corresponding measured operating pressure (plot line 360) along with measured operating pressure when traversing a straight path (plot line 362) for comparison. When growing the growing soft robot around a tortuous path, it was found that there was a negligible change in the operating pressure as a function of the robot length, as compared to a straight-line path. This suggests that the tortuosity of the path has limited (e.g., sub-exponential) effect on the growing behavior

### Soft Robots—Burrowing

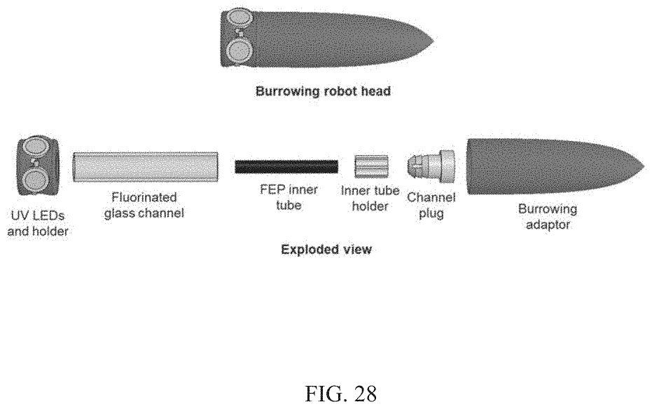

To evaluate an ability of the growing soft robot to burrow through soil or similar materials, an adaptor was created and assembled to the head of the example growing soft robot. FIG. 28 schematically illustrates the robot head adaptor used for burrowing testing. The growing soft robot example was operated to effect a burrowing-type growth effect in a transparent simulated soil. The transparent simulated soil was prepared by mixing 15 wt. % of hydrophobic fumed silica in mineral oil and then mixed using a motorized mixer. The synthetic soil was further dispersed and degassed for five minutes using a planetary mixer (Thinky ARE-310). Upon addition of the simulated soil to the burrowing testbed, the entire setup was placed under vacuum to remove any remaining air.

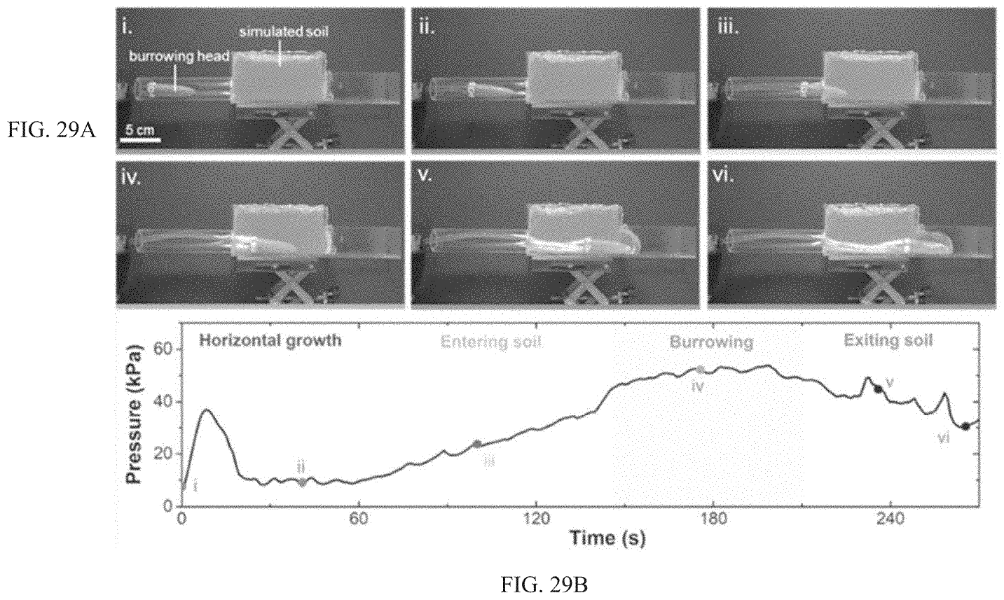

The images of FIG. 29A reflect the example growing soft robot navigated in/burrowing through the high impedance environment, i.e., a transparent simulated soil. The robot was found to exhibit a root-like ability to burrow through an impeded path while simultaneously generating a three-dimensional structure. Variations in fluid pressure were observed and are reported in FIG. 29B; the variations were found to correspond with the robot's interactions with the environment: a steady-state pressure for unimpeded horizontal growth, rising pressure while entering the simulated soil, a constant burrowing pressure with a fully submerged head, and a declining pressure exiting the simulated soil. At a known flow rate, sensing pressure deviations at the base of the growing soft robot, due to obstacles or changing environments encountered at the growing tip provides the growing soft robot a method to sense basic tip-environment interactions, resembling plant root stimuli response to changing soil impedance.

The polymerization extrusion systems and methods, as well as the growing soft robots, of the present disclosure provide a marked improvement over previous designs. The self-lubricating polymerization based extrusion of the present disclosure employs a lubricating component or agent (e.g., liquid block copolymer) that can wet the interface and form a lubricating layer spontaneously. The lubricating component is coupled with a polymerization of a flowing monomer species. The monomer fluid is used as a hydraulic fluid to drive the solid polymer from the die/channel and allows further monomer to be polymerized. The growing soft robots of the present disclosure effect growing via self-lubricating polymerization. The robot grows at a tip thereof by generating its own body with polymerization, which in turn acts as a conduit/supply tube for further monomer to be delivered to the tip for further polymerization.

Although the present disclosure has been described with reference to preferred embodiments, workers skilled in the art will recognize that changes can be made in form and detail without departing from the spirit and scope of the present disclosure.

What is claimed is:

1. A method of extruding a solid polymer body, comprising:
supplying a liquid polymerizable monomer solution to a channel of a channel structure, the solution including a polymerizable monomer resin and a lubricating agent; and
exposing the flowing monomer solution to a stimulus to polymerize and solidify the monomer into a solidified polymer body;
wherein the lubricating agent self-generates a lubricant layer at an interface of the solution with an inner surface of the channel structure;
and further wherein the supply of the monomer solution forces the solidified polymer body to be expelled from the channel structure.

2. The method of claim 1, wherein a solidified polymer body is continuously extruded.

3. The method of claim 1, wherein a solidified polymer body is extruded on a time-varying basis.

4. The method of claim 1, wherein the polymerizable monomer resin includes a photopolymerizable monomer.

5. The method of claim 1, wherein the polymerizable monomer resin includes a thermal polymerizable monomer.

6. The method of claim 1, wherein the step of exposing the flowable monomer solution to a stimulus includes directing at least one of electromagnetic radiation and heat toward the flowing monomer solution.

7. The method of claim 1, wherein the polymerizable monomer resin is formulated for at least one of photopolymerization, thermal polymerization, and catalytic polymerization.

8. The method of claim 1, wherein the polymerizable monomer resin includes a monomer selected from the group consisting of a thiol-ene based monomer, an acrylate, a methacrylate, a polyurethane acrylate, and an epoxide acrylate.

9. The method of claim 1, wherein the lubricating agent is selected from the group consisting of a block copolymer amphiphile, poly(dimethylsiloxane)-graft-poly(ethylene oxide) grafted copolymer (PDMS-PEO) containing ˜65% poly(ethylene oxide) content by weight, PDMS-b-PEG, PPG, and fluorinated PDMS-b-PEG.

10. The method of claim 1, wherein the channel structure is configured to selectively change a perimeter shape of the channel.

11. The method of claim 1, wherein the solidified polymer body has a profiled shape.

12. The method of claim 1, wherein at least one of the channel and the stimulus are varied spatially.

13. The method of claim 1, wherein at least one of the channel and the stimulus are varied over time.

14. A growing soft robot comprising:
a monomer supply source assembly including a reservoir containing a flowable polymerizable monomer solution and a pump fluidly connected to the reservoir;
a robot body having a tubular shape and formed of a polymer compatible with a polymerizable monomer of the monomer solution; and
a robot head including:
an outer channel structure defining a passageway, a leading end, and a trailing end opposite the leading end,
an inner tube disposed within the channel structure and defining an internal passage,
the inner tube and the channel structure combining to define a channel, a cover secured to the leading end of the outer channel structure and closing the passageway,
a stimulus source arranged to deliver a stimulus to a region of the channel,
wherein a terminal end of the inner tube is spaced from the cover;
wherein the growing soft robot functions to grow the robot body in response to a forced supply of the polymerizable monomer solution to an interior of the robot body, the supplied monomer solution flowing from the robot body into the internal passage, from the internal passage toward the cover, and from the cover into the channel where the monomer solution polymerizes to a solid polymer in the presence of localized stimulus from the stimulus source.

15. The growing soft robot of claim 14, wherein the polymerizable monomer includes a resin selected from the group consisting of a photopolymerizable monomer resin and a thermal polymerizable monomer resin.

16. The growing soft robot of claim 14, wherein the stimulus source is formatted to emit at least one of electromagnetic radiation and heat.

17. The growing soft robot of claim 14, wherein an arrangement of the stimulus source relative to the outer channel structure is one of:
outside of the outer channel structure; and
inside of the outer channel structure.

18. The growing soft robot of claim 14, wherein the stimulus source is arranged outside of the outer channel structure, and further wherein the outer channel structure is formed of a material transmissive to stimulus from the stimulus source, and even further wherein the inner tube is formed of a material that blocks stimulus from the stimulus source.

19. The growing soft robot of claim 18, wherein the stimulus source emits UV light.

20. The growing soft robot of claim 14, wherein the channel has a profile shape selected from the group consisting of regular and irregular.
